(19) United States
(12) Patent Application Publication
(10) Pub. No.: US 2009/0187583 A1
(43) Pub. Date: Jul. 23, 2009

(54) ENHANCED LABEL CLAIM VALIDATION

(75) Inventors: William R. Pape, Los Ojos, NM (US); Andrew J. Dolan, Arvada, CO (US)

Correspondence Address: FISH & RICHARDSON P.C., P.O. BOX 1022, MINNEAPOLIS, MN, 55440-1022, US

(73) Assignee: Aginfolink Holdings, Inc., A BVI Corporation, Tortola (VG)

(21) Appl. No.: 12/062,088

(22) Filed: Apr. 3, 2008

Related U.S. Application Data
(60) Provisional application No. 61/022,192, filed on Jan. 18, 2008.

(51) Int. Cl. G06F 17/30

(52) U.S. Cl. 707/100; 707/E17.005

(57) ABSTRACT

The enhanced validation of a label claim, in which identification information uniquely identifying an item that has moved through a node in a supply chain is received, the item being marked with a label claim. Event data associated with the uniquely identified item is received from the node, and received event data that validates or invalidates the label claim is output, in real time or near real time to receiving the identification information.

### CROSS-REFERENCE TO RELATED APPLICATION

This application claims the benefit of U.S. Provisional Patent Application No. 61/022,192, filed Jan. 18, 2008, which is incorporated herein by reference.

### FIELD

The present disclosure generally relates to the tracking of items in a supply chain.

### BACKGROUND

In response to recent recalls of consumer products, such as food, toys, pet food, clothing and toothpaste, as well as scares relating to E. coli and bovine spongiform encephalopathy (BSE, or “mad cow”) contamination of beef, the average consumer has become aware of a lack of transparency in product supply chains, particularly supply chains that cross international borders.

Even after being notified of a product recall or scare, a consumer has few options other than to discard all items that could potentially be affected, or to risk their own health and safety by continuing to consume or use the potentially affected items. The concomitant consumer ignorance that results from the lack of transparency in the supply chain often leads to this or other wasteful responses, which are oftentimes completely unnecessary. All of these factors may lead consumers to feel generally unsettled about the items they wish to purchase, and thus may present a barrier to trade and commerce.

### SUMMARY

The apparent lack of product safety that consumers perceive from these latest incidents have influenced consumers to be more wary of the safety of the products they use and consume. While a consumer previously may have trusted inspectors within supply chains to ensure the safety of products, consumers now want to be able to determine for themselves whether a product is safe or appropriate for use or consumption, or whether the product lives up to its claims.

According to the present disclosure, a user can enter information that uniquely identifies an item into a user interface in order to validate a label claim associated with the item, in real time or near real time. Based on the identifying information, nodes in a supply chain are polled or queried for event data or other information regarding the item, and the event data is appropriately reformatted and automatically compared against the label claim. In addition to outputting the raw event data itself, the user interface may output indicia that validates or invalidates the label claim, thereby rendering the supply chain for the uniquely identified item more completely transparent.

According to one general implementation, a computer-implemented method includes receiving identification information uniquely identifying an item that has moved through a node in a supply chain, the item being marked with a label claim, and receiving, from the node, event data associated with the uniquely identified item. The method also includes outputting received event data that validates or invalidates the label claim, in real time or near real time to receiving the identification information.

Implementations may include one or more of the following features. For instance, receiving the identification information may further include generating a user interface, and receiving the identification information from a user via the generated user interface. The identification information may be received using a radio frequency identification device (RFID) reader. A data collection interface may be established between the node and a transaction database, the data collection interface allowing the transaction database to receive the event data associated with the uniquely identified item from the node. The event data may relate to supply chain processing of the uniquely identified item at the node.

In further examples, the identification information may be received before the event data is received from the node. A data conversion interface may be established between an output device and a transaction database, the data conversion interface allowing the output of the received event data from the transaction database using the output device. The label claim of the item may be automatically validated based on the received event data. Event data associated with the uniquely identified item may be received from a second node, and the event data received from the node and the second node may be reformatted, where outputting the received event data further comprises outputting the reformatted event data received from the node and the second node.

In still further examples, identification information uniquely identifying a component of the uniquely identified item may be received based on outputting the received event data, component event data associated with the component may be received from a second node on the supply chain, and received component event data that validates or invalidates the label claim may be output, in real time or near real time to receiving the identification information uniquely identifying the component. The item may be transformed from a first product to a second product at the node, and the output received event data that validates the label claim may further include event data associated with the first product and event data associated with the second product. The first product may be a living product, such as a living animal, fruit or vegetable, where the second product is a non-living product, such as a meat product or a harvested fruit or vegetable.

Additionally, the event data further may further include an event identification number attribute, a type attribute, a nomenclature attribute, a quantity attribute, a unit-of measurement attribute, a parent event identification number attribute, a source attribute, a brand attribute, a trademark attribute, or a child event identification number attribute. The label claim may be an organic claim, a natural claim, a no hormone claim, a point-of-origin claim, an ingredients claim, a vegetarian contents claim, a cruelty free claim, a drug claim, a cosmetic claim, a cage-free claim, a brand claim, a trademark claim, or a compliance claim. The identification information may be physically affixed to the item or packaging of the item, and the label claim may be physically affixed to the item or packaging of the item. The event data may be associated with a vaccination event, a harvesting event, a birthing event, or a transportation event, a treatment event, a planting event, a location event, a containering event, or a cohorting event.

According to another general implementation, a device includes an interface configured to receive identification information uniquely identifying an item that has moved through a node in a supply chain, the item being marked with a label claim, to receive, from the node, event data associated with the uniquely identified item, and to output received event data that validates or invalidates the label claim, in real time or near real time to receiving the identification information.

According to an additional general implementation, a computer program product is tangibly embodied in a machine-readable medium. The computer program product includes instructions that, when read by a machine, operate to cause a data processing apparatus to receive identification information uniquely identifying an item that has moved through a node in a supply chain, the item being marked with a label claim, to receive, from the node, event data associated with the uniquely identified item, and to output received event data that validates or invalidates the label claim, in real time or near real time to receiving the identification information.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1 is a conceptual diagram of an exemplary system for providing the enhanced validation of label claims.

FIG. 2 is a block diagram of an exemplary system for validating a label claim.

FIG. 3 is a flowchart of a process for performing enhanced validation of a label claim.

FIG. 4 provides a brief conceptual overview of a process for assigning a unique identifier to an item in a supply chain.

FIGS. 5 to 10 illustrate exemplary user interfaces for entering identification information and outputting event information that validates a label claim.

FIG. 11 depicts the exterior appearance of a an exemplary system including a user device and transaction database server.

FIG. 12 illustrates the internal architecture of the user device of FIG. 11.

FIG. 13 provides examples of the automatic determination of a characteristic of an item where an earlier state of the item is unidentifiable.

In the drawings, common reference numbers refer to corresponding parts throughout.

### DETAILED DESCRIPTION

Using the enhanced label claim validation approach described herein, consumers of a product may research the supply chain history of a product in real-time or near real-time, in order to detect false label claims and make well-informed decisions regarding whether the item is worthy, safe, or appropriate for consumption, transportation or use. Using this approach, a consumer may avoid the unintentional consumption or use of items that are unfit or unsafe, that originate from suppliers that make inaccurate claims, or do not comply with their moral, ethical, religious values or deep-seated personal preferences, for example where the item's label makes an intentionally or unintentionally false claim.

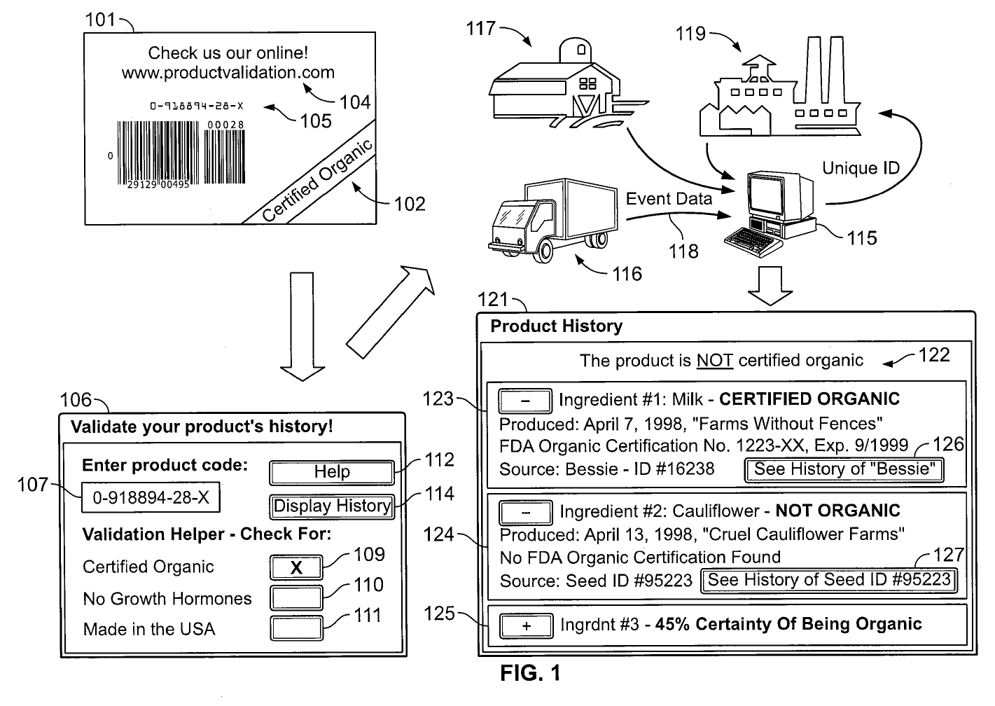

FIG. 1 is a conceptual diagram of an exemplary system for providing the enhanced validation of label claims. Initially, according to one implementation, a “label claim” is intended to refer to a claim, or an assertion of something as a fact, associated with a “label” or “mark,” which is an affixed, impressed or otherwise associated device, symbol, inscription, etc., serving to give information, identify, indicate origin or ownership, attest to character or comparative merit, or the like, as a trademark, of an item that has moved through at least a portion of a supply chain. While a label claim is described herein as a physical label attached to a physical item, the label claim need not be physically embodied (e.g. may be a contract provision or a verbal claim), may not be attached to the item, and may be associated with an item that is also not itself physically embodied.

“Real time” and “near real time” refer to instantaneous or near instantaneous processing, such that a user of the system perceives no delay or a short delay between the time information is requested and the time information is provided. Although near real time access to data may refer to access that occurs within a few seconds or minutes, for complex queries or using systems with limited computational resources, near real time access to data may take longer. In any case, near real time access is contrasted with systems require a user to wait for extended periods of time, that require manual intervention, collation or analysis, that allow a user to perceive onerous or extended delays, or that require a user to participate in multiple computing sessions before results are output.

Although the automatic validation of label claims is described in many examples herein as occurring in real time or near real time, in other examples longer (including much longer) time frames are contemplated. For instance, the validation of a label claim may invoke a manual processing operation which may cause the label claim to be validated over the course of several days. Furthermore, the label claim validation result may be “output” to the user via postal mail or in person, in which the result may take days, weeks or months.

Naturally then, an “item” is one or more tangible or intangible article or commodity, while a “supply chain” refers to a sequence of processes or locations involved in the production and distribution of the article or commodity. Within the supply chain, the item or article may undergo a series of state transformations, such as where the item is transformed from a living state to a non-living state, where the item is processed from a first product into a second product, where the item is divided into constituent parts or into multiple products, or where the item is combined with other items.

By way of example, an item may be a consumer product such as food or components of food, a toy, a consumer electronic device, a living plant or animal, a fluid, a container, a fruit or vegetable, a pharmaceutical, a vehicle, or a group, batch, lot, cluster, or other plurality of items. Similarly, the item may represent an intangible item, such as an electronic mail message, a virtual item in a virtual universe (such as a virtual item like a weapon, a good, or land purchased in the SECOND LIFE® or WORLD OF WARCRAFT® virtual universes), a right, a title, or an obligation.

Using fruit as an example, the item may include a physical label that is affixed or attached to the fruit, or packaging for the fruit, a palette or other container that holds multiple fruit packages, or a truck or warehouse that transports or stores the fruit. The item may be associated with a label that is not physically affixed to the fruit, such as an advertising banner that hangs over a shelf of fruit, or a verbal assertion made by a fruit hawker. The label claim and/or a unique identified of the item may be stored in an identification device, such as an RFID tag, affixed to the item.

In any case, the label makes a claim that negatively or positively attests to some characteristic of the item. The label claim may attest to the organic character of the item (“Certified Organic,” “100% Organic,” “Natural,” “Guilt Free”); may attest to the natural origin of the item (“Farm Raised,” “No Artificial Colors Or Sweeteners,” “Ocean Caught”); may attest that the item was not treated with hormones (“No Growth Hormone,” “rbST negative”); may attest to the location of origin of the item (“Made in the U.S.A.,” “Real California Cheese,” “Factory Authorized,” “Under Warranty”); may attest to the ingredients of the item (“Peanut free,” “Contains Phenylalanine”); may assert that the item is vegetarian or vegan friendly (“Does not contain milk or eggs,” “Flavored with soy-based simulated bacon”); may assert that the item is cruelty-free (“Product not tested on animals,” “Simulated fur”); may be a drug claim that asserts that the item alters the physiology or function of any part of the human body (“Prevents erythema caused by sunburn”); may be a cosmetic claim that does not describe a physiological effect of the body (“Fragrance Free,” “No Perfumes”); may assert that an animal that produced the item was not caged (“Cage-free,” “Free Range”); or may assert that the item is in compliance with a standard or has been approved by a body (“UL Listed,” “IEEE-1394 compliant,” “Union Labor,” “No Child Labor,” “Authorized Transaction,” “Good Housekeeping Seal Of Approval,” “Oprah Book Club Selection,” “Fair Trade”). In short, a label claim can be any assertion about anything.

As illustrated in FIG. 1, a label 101 affixed to the packaging of an item or to the item itself includes a label claim 102, that asserts that the item is “Certified Organic.” To be certified as an organic food, generally it must be shown that use of synthetic chemical inputs (e.g. fertilizer, pesticides, antibiotics, food additives, etc) and genetically modified organisms has been avoided; that farmland has been used that has been free from chemicals for a number of years (often, three or more); that an audit trail of detailed written production and sales records has been established; that strict physical separation of organic products from non-certified products has been established and respected; and that periodic on-site inspections have occurred.

The qualities or characteristics that make a food item “organic” or, conversely, preclude a food item from being called “organic” may be encoded using rules, such that a condition that a food item whose supply chain event history satisfies or does not satisfy the rule may be validated or invalidated as an organic item, thereby validating or invalidating a label claim. A rule that requires, for instance, that the farm be free of chemicals would be violated by first event data received from a first source in real time that indicates that a particular farm is the origin of the item, and second event data received from a second source in real time that indicates that the particular farm received pesticide treatment with a particular period of time.

In order for the user to validate the label claim, the label 101 includes a validation resource 104 (such as a Uniform Resource Locator (URL) or a telephone number), as well as a unique identifier 105 (“0-918894-28-X”) that uniquely identifies the item or collection of items. The user may be a living or automated end-user of the product (such as a consumer), or the user may some other entity disposed at the origin or mid-point of the supply chain. Although the term “validation” is used herein throughout to generally refer to a process for determining whether a label claim is accurate, the “validation” process may support an approval, an authentication, an authorization, a certification, a confirmation, a corroboration, endorsement, a legitimization, ratification, a sanction, a substantiation, or a verification.

Using a user interface 106, the user enters the unique identifier 105 into text box 107, and selects the type of label claim that the user wishes to validate. For instance, the user checks “Certified Organic” checkbox 109 to verify the validity of the “Certified Organic” label claim 102. Although the label does not explicitly make a “No Growth Hormone” or “Made In The USA” label claim, the user could also select checkboxes 110 and 111, respectively, to verify whether those label claims could be made for the item. Although the selection of a label claim to validate is illustrated in this example as a manual process, in other arrangements the enhanced label claim validation approach may automatically determine label claims that may apply (or be “appropriate”) to a item, based on receiving the unique identifier 105, or appropriate unique identifiers of products may be automatically determined based on receiving a selection of a label claim that is to be satisfied.

Using a help control 112, the user may seek automated assistance. In one example, the automated assistance function may access a database that stores a graphic that displays where the unique identifier 105 is located for various items, that stores a textual description of the location of the unique identifier 105, or that directs the user to a technical support specialist. Once the unique identifier 105 is entered into the text box 107, the user can select a “display history” form submission control 114.

Upon detecting that the form submission control 114 has been selected, a transaction database 115 queries various nodes of a supply chain in real time or near real time to gather event data or other information stored at one or more nodes that relate to events associated with the submitted unique identifier 105. For instance, the transaction database may query or poll a vehicle 116 that transported the item, a farm 117 that raised or harvested the item, a factory 119 that processed the item, a governmental or non-governmental entity that certifies compliance of the item, or any other node.

It may occur that the transaction database 115 queries all nodes in the supply chain, or the transaction database 115 may query a portion of the nodes in the supply chain based on the unique identifier entered. Furthermore, it may occur that the transaction database 115 queries a first node or set of nodes in the supply chain, processes received data, and subsequently queries a second or further node or set of nodes. For example, if the first query receives event data identifying an origin of an item, a second or subsequent query of a supply chain or non-supply chain node (such as a governmental node) may reveal information pertaining to the origin of the item. If the origin is a farm or a manufacturing facility, for example, these cascading queries could be used to determine if the origin is certified by a governmental agency or other certification body.

For each of the nodes that store event data relating to the item, event data 120 (or an indicia of the occurrence or non-occurrence of an event, or the existence or non-existence of event data 120), are transmitted from each node to the transaction database 115. Since the events may be stored in various data formats, the transaction database 115 reformats the data to a unified data format, such as a format based on eXtensible Markup Language (XML), and transmits the reformatted event data to the user. Furthermore, it may automatically determined whether the item satisfies the label claim 102, based on the received event data 117, or the user may be given the option of manually validating the received event data 117 itself.

The reformatted event data is output on a user interface 121 to thereby validate or invalidate the label claim. Specifically, based on the automatic determination, the user interface 121 includes indicia 122 that indicates that this item does not satisfy the label claim, in that the item is not certified organic. The indicia may be a “yes” or “no” type indicia that indicates that the label claim is or is not validated, the indicia may display a probability that the label claim is or is not validated, or raw event data or other data may be output.

“Yes” or “no” (‘binary’) type indicia can be output if the label claim is determined to be 100% valid or 100% invalid, or a threshold can be preset, set by a manufacturer or user, or automatically determined based on past use, where the threshold allows a label claim to be validated or invalidated even if some event data is missing or contradicts the validation or invalidation. For instance, if event data indicates that only 5% of a farm has been sprayed for pesticides and a threshold of 90% certainty has been set by the user, the enhanced label claim validation application may output an indicia that an item had not been sprayed for pesticides even though there is a small chance that the item has been sprayed. Such a threshold is helpful since it may be impossible to prove or disprove a label claim with 100% certainty.

In addition to displaying event data for the item itself, the user interface 121 displays historical event data for each component, constituent part, ingredient, or previous state or phase of the item. For instance, the user interface 121 includes expanding regions 122, 124 and 125 that display or otherwise output event data for three ingredients of the item. The expanding region 122 displays production event data (“Produced: Apr. 7, 1998”); origin location event data (“Farms Without Fences”); governmental certification compliance event data (“FDA Organic Certification No. 1223-XX, Exp. 9/1999); and pre-transformation event data (“Source: Bessie —ID # 16238”).

Since ‘Ingredient #1,’ which is displayed in expanding region 122, is milk, the user may wish to view event data regarding the source of the milk or, more generically, the product that was transformed to produce the item or ingredient. Since the pre-transformation product is a cow (“Bessie”) which also has a unique identifier (“16238”), the user may select a control 126 to see the event history of the cow. For instance, although the expanding region 122 indicates that the milk is certified organic based on governmental certification compliance event data, the user may effectively treat that event data as a label claim, and may investigate the validity of that claim as well, in a similar manner as they investigated the end product.

In that regard, the user may investigate the supply chain of any uniquely identified items though an iterative, recursive, or retrospective process. Specifically, products, and then components or previous states or phases of those products, are validated from end-point to origin-point, notwithstanding the fact that the uniquely identified items may change their nature or state through supply chain processes, or that certain intermediate phases or states may be not uniquely identifiable or unidentifiable.

The expanding region 124 displays event data for the ingredient “cauliflower,” which was used in the production of the uniquely identified item. Since event data relating to an FDA organic certification of the cauliflower was not found, the item is then not deemed to be certified organic based on the application of a rule or upon reviewing event data, and the label claim 102 is thereby invalidated by this event data. As above, since the event data includes a unique identifier (“Seed ID #95223”) of the cauliflower, the user may select a control 127 to research the event history of the cauliflower in turn.

In summary, a user can enter information that uniquely identifies an item into a user interface, in order to validate a label claim associated with the item, in real time or near real time. Based on the identifying information, nodes in a supply chain are polled or queried for event data or other information regarding the item, and the event data is appropriately reformatted, and automatically compared against the label claim. In addition to outputting the raw event data itself, the user interface outputs indicia to validate or invalidate the label claim, thereby rendering the supply chain for the uniquely identified item completely transparent.

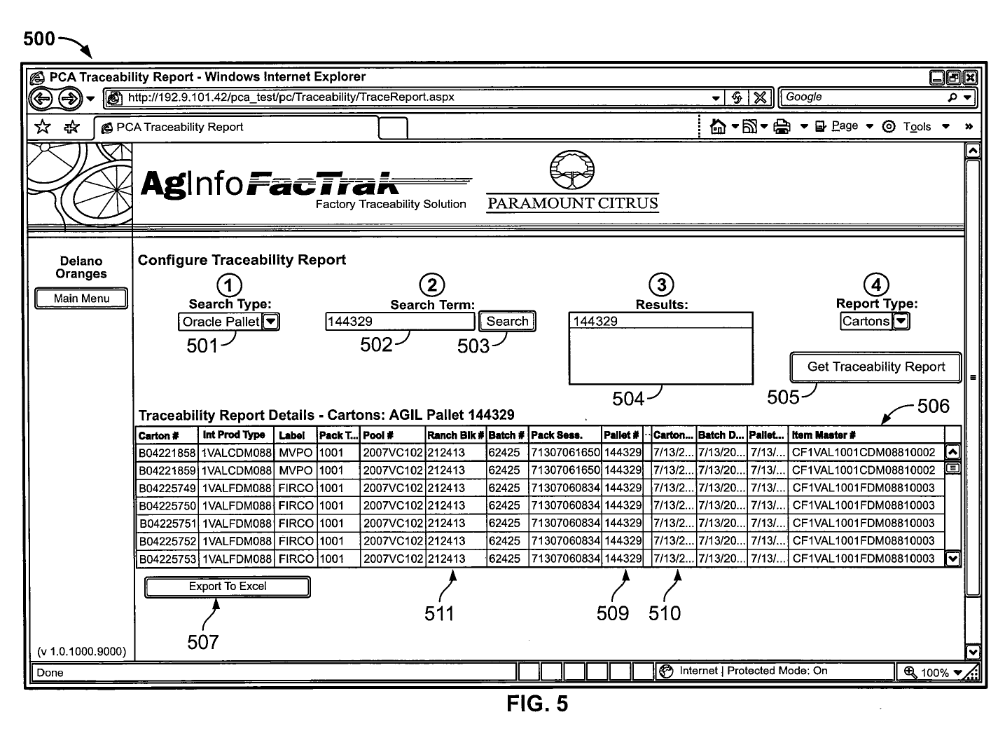

FIG. 1, supra, and FIGS. 5 to 10, infra illustrate various user interfaces for validating label claims, which are implemented using various controls or widgets, that each allow for different levels of interaction and functionality. In each case, it is noted that the particular controls used, and the particular functionalities allowed, are merely exemplary. For the sake of brevity, it is further noted that any user interface that allows for the input of identification information and the output of label claim validation information may be used, and that the selection of particular components, controls, widgets or functionalities generally depends upon the intended user of the user interface, and the level of control desired.

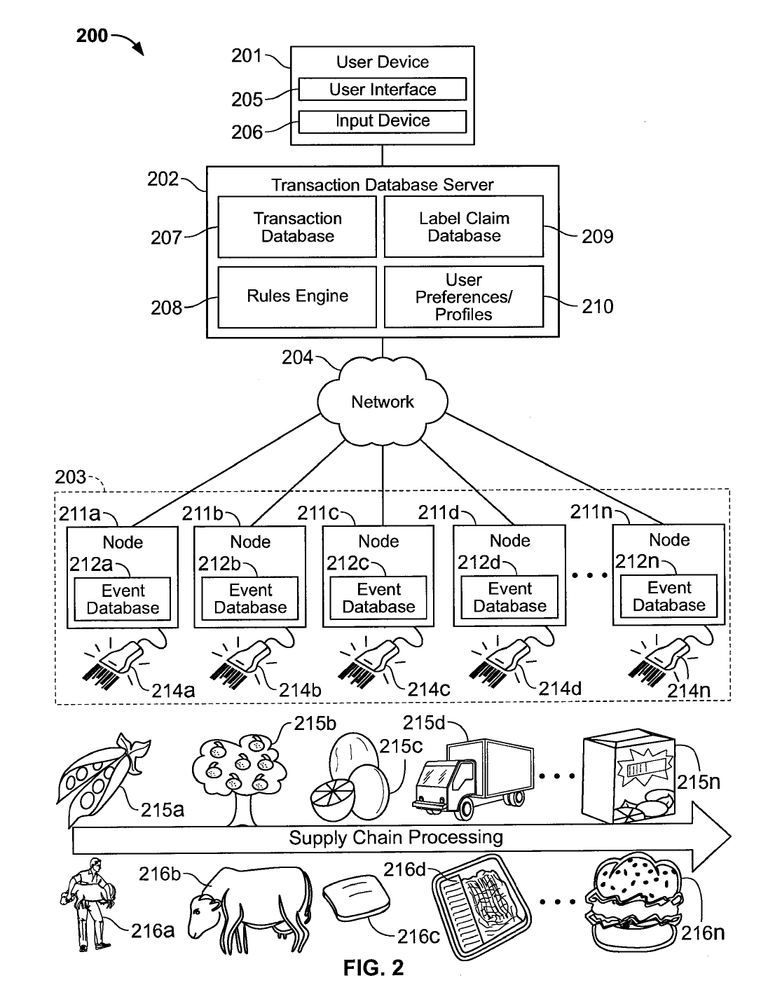

FIG. 2 is a block diagram of an exemplary system 200 for validating a label claim. Briefly, the system includes a user device 201, and a transaction database server 202 connected to nodes of a supply chain 203 via a network 204. Using the system 200, a user may investigate the validity of a label claim associated with an item that has been processed by the supply chain 203, thereby making the supply chain 203 increasingly transparent.

In more detail, and among other things, the user device 201 includes a user interface 205, such as a display device or a speaker, that outputs textual, sound or graphical data, including event data that validates the label claim, to the user. The user device also includes an input device 206, such as a mouse, a keypad, a microphone or other input mechanism, that receives or accepts commands from the user or an automated system.

The transaction database server 202 includes a transaction database 207 that stores events associated with items in the supply chain, as well as addresses or identifiers of resources external to the transaction database server 202 that also store events. In one example implementation, the events in the transaction database 207 are stored in a uniform event storage format, such as an XML-based format, while externally stored events may be stored in various event storage formats, including proprietary event storage formats. The transaction database 207 may also store indicia received from nodes of the supply chain 203 that indicate whether or not a particular item has or has not, or is likely to have had or had not, been processed at a particular node or within a particular supply chain.

Furthermore, the transaction database server 202 includes a rules engine 208 that allows the transaction database server to automatically validate or invalidate label claims based on applying rules to received event data. For instance, for the label claim “Never Frozen” may include a rule that requires all event data relating to a temperature reading event to be greater than 0° C. (32° F.), as a temperature reading at or below that temperature would indicate that the item may have frozen.

Although rules may be used to validate label claims, in other cases the event data itself may provide sufficient to validate or invalidate a label claim. For instance, event data itself may indicate that an item is organic or not organic. Since event data is self-serving and may itself be manipulated or falsified, however, the enhanced label validation process may choose to ignore event data that itself makes such an assertion, may afford this type of event data lesser value, or may choose to use this event data only in certain circumstances. For instance, the enhanced label validation process may ignore event data that indicates that an item is organic, but may use similar event data that indicates than an item is not organic.

Table 1, below, illustrates sample rules used to aid the interpretation of event data and to thereby validate label claims.

TABLE 1
Sample Rules

| Label Claim | Rule: |
|---|---|
| Real California Cheese | Event = Milk Extraction |
| | Event Data (Location) = California; and |
| | Event = Processing |
| | Event Data (Location) = California. |
| No Growth Hormone | Event = Vaccination |
| | Event Data (Type) ≠ BGH, and |
| | Event Data (Type) ≠ rBGH, and |
| | Event Data (Type) ≠ BST, and |
| | Event Data (Type) ≠ rBST. |
| Made In Japan | Event = Manufacture |
| | Event Data (Factory Country) = Japan or |
| | Event Data (Factory City) = Osaka |
| | . . . |
| Gluten Free | Event = Manufacture |
| | Event Data (Ingredient) ≠ Gluten, or |
| | Event Data (Ingredient) ≠ Gliadin, or |
| | Event Data (Ingredient) ≠ Glutenin. |
| Kosher | Event = Slaughter |
| Halal | Event Data (Slaughter Facility ID) = <certified |
| | facility>, and |
| | Event Data (Slaughter Personnel) = <certified |
| | individual>; and |
| | Event = Storage |
| | Event Data (Stored With) ≠ Milk. |
| Unscented | Event = Manufacture |
| | Event Data (Ingredient) ≠ “fragrance” or |
| | “perfume” |

The transaction database server 202 also includes a label claim database 209 that identifies item types based on input identification information, and that further determines appropriate label claim to validate for identified item types. Where a user supplies identification information for an item but does not supply a label claim to validate, the label claim database may determine the type of item that the user is referring to based upon the content or format of the identification information, and may automatically or dynamically select one or more label claims to validate without querying the user for additional information.

In addition to or instead of storing appropriate label claims for identified items, the label claim database 209 may also store known label claims associated with specific items. For instance, if a clothing retailer may proudly assert that none of their clothing is made using child labor, then the label claim database 209 may automatically associate a “No Child Labor” label claim with all items manufactured or sold by the clothing retailer. As such, if, as so commonly happens, the retailer itself is not aware that its subcontractors are illegally using child labor, the enhanced label claim validation application may assist with detecting this impropriety in every case that identification information for any of the retailer's products is input.

The transaction database server 202 also stores user preferences/profiles 210, which include explicitly provided or inferentially determined information concerning the user using the enhanced label claim validation application. For instance, a vegetarian may explicitly denote that they want all food items checked for meat content or, similarly, through continued selection of a vegetarian label claim validation function, the enhanced label claim validation application may infer (based on rules stored in the rules engine 208) that a particular user is a vegetarian and that a vegetarian label claim validation function is always to be run for food items.

The user preferences/profiles 210 may also describe an authorization level of a user to view certain event data. For instance, a generic consumer may given authorization to view an automatically determined label claim validation result, while a wholesaler or middleman may be given authorization to view more granular data, such as pricing or sales volume event data. Certain users may be assigned authorization levels which do not allow them to perform claim validations at all.

Other authorization levels may allow validations to be run, but for results to be output only if a claim is validated or invalidated. For instance, a company may effectively allow users to check the company's internal processes by allowing them to run claim validations, but may output an error message to the user and deliver invalidating claim result to the company if a claim turns out to be invalid. This type of selective authorization may allow a company time to get ahead of a potentially damaging story if, for circumstances outside of the company's control, a customer would otherwise discover that a claim is invalid.

The supply chain 203 includes any number of nodes, such as nodes 211a to 211n. Each node includes an event database, such as event databases 212a to 212n, that each store events associated with items in the supply chain 203. Furthermore, nodes may include input devices (such as bar code readers 214a to 214n). For instance, the node 211b may store events read by bar code reader 214b or other input devices associated with the node 211b, or the node 211b may store events read by other nodes, such as nodes 211a and/or 21 in.

As items are transported through and processed by the supply chain 203, events are generated and stored, thereby providing a tracking history for each event. In one example, the supply chain 203 may be used to track items that do not undergo any state changes or transformations, such as a supply chain that receives a finished product, processes the finished product, and transfers out the finished product to outside of the supply chain 203. In another example, the supply chain 203 is used to track items that undergo state changes or transformations, such as a transformation that changes the item from a living state to a non-living state, or that changes the item from a first product to an Nth product (N being any integer) derived from the first product. In this latter example, the stored events can be used to trace the processing history of the Nth product through to the first product, for the purpose of validating a label claim relating to the Nth product or the first product, and for other purposes.

As shown in FIG. 2, items 215 and 216 undergo several state or phase transformations within the supply chain. For instance, seeds 215a are processed at the node 211a, while a tree 215b that grows from seeds 215a is processed at the node 211b, a fruit 215c that grows on the tree 215b is processed at the node 211c, a container 215d of the fruit 215c is processed at the node 211d, and juice 215n made with the fruit from the container 215d (including the fruit 215c) is processed at the node 21 in. Since the validation of a label claim on the juice box that stores the juice 215n may benefit from or require event data from stored events associated with the seeds 215a, the juice 215n in the juice box and the seeds 215a are considered to be one “item,” in various forms, phases or states. More particularly, the seeds 215a and the tree 215b are considered to be living forms or versions of the item 215, while the harvested fruit 215c and the juice 215n in the juice box are considered to be non-living forms or versions of the item 215.

As long the seeds 215a, the tree 215b, the fruit 215c, the container 215d, and the juice 215n are each associated with a unique identification number, the item 215 can be iteratively tracked through its initial state, based on event data associated with later states. For instance, in accessing event data or validating a label claim associated with the juice 215n, the user or enhanced label claim validation application may determine that the juice was conveyed the uniquely identifiable container 215d.

In subsequently accessing the transportation history event data of the container 215d, the user or transactional database server may determine that the container 215d contains uniquely identifiable fruit 215c, which may be subsequently determined to come from a uniquely identifiable tree 215b, which was planted using uniquely identifiable seeds 215a. In another implementation, the item 215 can be iteratively tracked through its initial state even if an intermediate state is not identified or identifiable.

In this regard, the entire event history of the item is made transparent to a user, by linking together various subsequent phases or states of a product with previous uniquely identifiable phases or states. As such complex label claim validation routines or processes may be performed on later states or phases of an item, to determine whether earlier states or phases of the item met certain conditions. Specifically, a user could enter a unique identifier associated with the juice 215n to determine whether, in violation of a label claim, contract requirement, or personal values, the seeds 215a were planted using migrant farm workers.

Using the unique identifier, the transaction database server could query and access event data of the juice 215n to iteratively access the unique identification information of the container 215d, then the fruit 215c, then the tree 215b, then the seeds 215a, then determine based planting event data queried based on the unique identifier of the seeds 215a, event information exposing the identity of the planter of the seeds 215a. Based on this accessed event information, the label claim, contract requirement, or moral restriction could be manually or automatically validated.

If a middle phase or state of the item 215, such as the fruit 215c, does not have a unique identifier, it is still possible for the transaction database server to estimate the unique identifier of a previous phase or state of the item, and to make a guess regarding whether the label claim is valid. If the validity of the label claim is not ascertained with complete certainty, an indication as such may also be output to the user. Using the fruit example, the transaction database server may determine, based on the unique identity of the fruit 215c that the fruit 215c came from a uniquely identifiable farm that included uniquely identifiable trees, but the unique identification information of the tree that the fruit 215c was harvested from may be missing.

By querying nodes using the unique identifier of the farm itself, that is the unique identifier of the entity that encompasses or includes all possible trees, the transaction database server may determine a probability of each uniquely identifiable tree on the farm being the tree from which the fruit 215c was harvested and, consequently, the probability that particular, uniquely identifiable seeds that eventually grew into the identified trees were the source of the fruit 215c.

Further, the enhanced label claim validation application may cohort the trees, by grouping together those trees that were grown from uniquely identifiable batches of seeds, and generate a likelihood or probability that the fruit 215c was harvested from a particular, uniquely identifiable seed batch based on the number and size of each tree cohort. Despite the fact that event data is gathered for multiple or various states or phases of the item 215, the event data for the earliest desired or available phase or state of the item 215 is gathered in real time to receiving the identification information for the latest phase or state of the item.

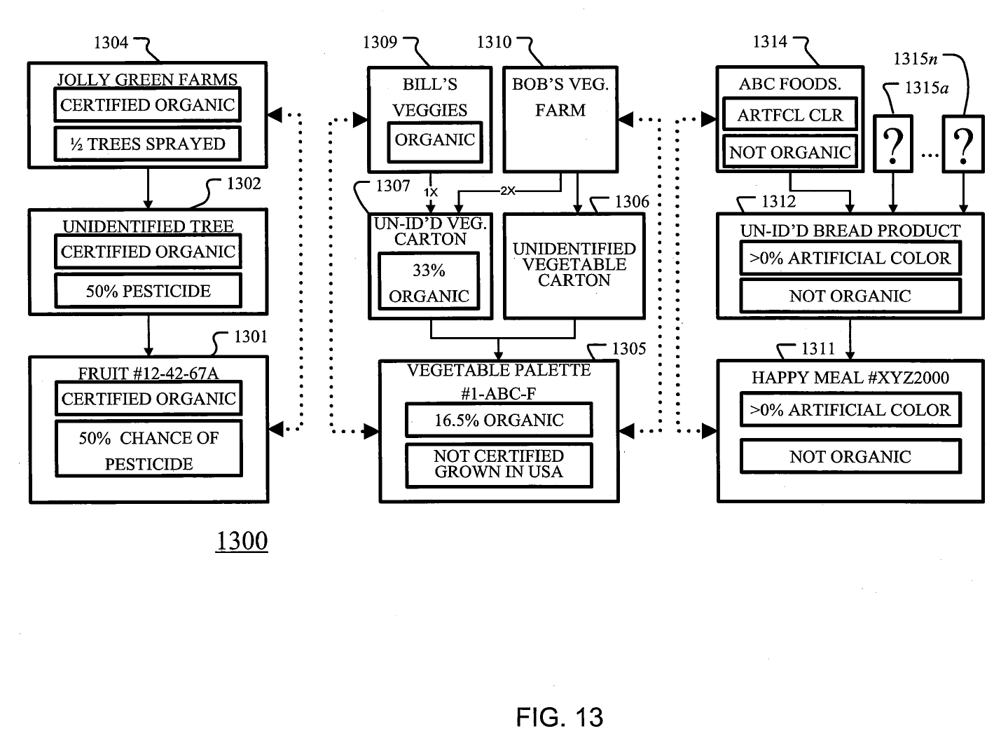

Referring ahead briefly, FIG. 13 provides several examples of how an a characteristic, trait or quality of an item can be automatically determined or deduced when an earlier state, origin, or ingredient of the item is unavailable or unidentifiable. In a first scenario, a uniquely identifiable fruit 1301 has been harvested from an unidentifiable tree 1302, however event data indicates that the identifiable fruit 1302 originated from identifiable farm 1304 or that the unidentifiable tree 1302 grew on the identifiable farm 1304. Characteristics or traits of an item (the fruit 1301) may still be determined if the item necessarily originated from another identifiable origin, source, state or item (the farm 1304).

Ignoring for a moment any factual inconsistency resulting from a origin potentially having these two example characteristics, event data associated with the farm 1304 indicates that the farm 1304 is certified organic, and that half of the trees have been sprayed with pesticides. Despite the fact that the tree 1302 is unidentified, it can still be automatically determined that the fruit 1302 also is certified organic and that it has a 50% probability of pesticide application since it necessarily originated from the farm 1304. This information may be displayed to a user via a user interface, or may be applied to a rule in the rule engine to validate a label claim.

In a second scenario, a uniquely identifiable palette 1305 packages unidentified cartons 1306 and 1307 of vegetables that came from one of two sources, farms 1309 and 1310. Although it is not possible to uniquely identify the cartons 1306 and 1307, it is possible to automatically determine characteristics (or probabilities of characteristics) of the palette 1305 if the characteristics of all of the possible sources or origins are known. For instance, event data associated with the farm 1309 indicates that the farm 1309 is certified organic, and that the farm 1310 (which is not certified organic) provides twice as many vegetables into the packaging process of the carton 1307 as the farm 1309.

From this information, it can automatically be determined that vegetables stored the carton 1307 have a 33% chance of being from farm 1309, and thus have a 33% chance of being certified organic. Since the palette 1305 includes vegetable containers from a process that produced the carton 1307 as well as an equal number of vegetable containers from a process that produced the carton 1306 (which is known to originate from the farm 1310), it can be automatically determined that the vegetable palette 1305 includes vegetable cartons that have a 16.5% chance of coming from farm 1309, and thus have a 16.5% chance of being certified organic.

Thus, despite the fact that the cartons 1306 and 1307 are unidentified, it can still be automatically determined that there is some probability that the palette 1305 includes some organic vegetables. This information may be displayed to a user via a user interface, or may be applied to a rule in the rule engine to validate a label claim. Since some label claims, such as a “certified grown in the USA” label claim may require some affirmative event data to validate that claim, and since neither farms 1309 or 1310 include that characteristic, it may be definitively determined that the palette 1301 does not include vegetables that carry that certification.

In a third scenario, a uniquely identified food product 1311 is made from an unidentified bread product 1312 includes ingredients (such as flour, yeast, sesame seeds, etc.) that come identifiable manufacturer 1314 and multiple identifiable or unidentifiable sources 1315a to 1315n. Event data associated with the identifiable manufacturer 1314 indicates that the manufacturer 1314 adds artificial colors to all of its ingredients, and that its ingredients are not organic. From this event data alone, regardless of the characteristics of the sources 1315a to 1315n, it can be determined that the food product 1311 includes at least some artificial color, and is not organic. This information may be displayed to a user via a user interface, or may be applied to the rule engine to validate a label claim.

Referring back to FIG. 2, calf 216a is processed at the node 211a, while a cow 216b (representing the full-grown calf 216a) is processed at the node 211b. A carcass 216c of the cow 216b is processed at the node 211c, ground beef 216d derived from the carcass 216c is processed at the node 21 id, and a hamburger 216n that is made from the ground beef 216d is processed at the node 21 in. Since the validation of a label claim on the hamburger 216n may benefit from or require data from stored events associated with the calf 216a, the hamburger 216n and the calf 216a are considered to be one “item,” in various forms, phases or states. The calf 216a and the cow 216b are considered to be living forms or versions of the item 216, while the carcass 216c, the ground beef 216d, and the hamburger 216n are considered to be non-living forms or versions of the item 215.

As long the calf 216a, the cow 216b, the carcass 216c, the ground beef 216d, and the hamburger 216n are each associated with a unique identification number, the item 216 can be iteratively tracked through its initial state, based on event data associated with later states. For instance, in accessing event data or validating a label claim associated with the hamburger 216n, the user or transactional database server may determine that the hamburger 216n was made with, among other things, the ground beef 216d. In subsequently accessing the event data of the ground beef 216d (in addition to or instead of accessing the event data of other ingredients or components of the hamburger 216n, such as the lettuce or the hamburger bun), the user or transactional database server itself may determine that the ground beef 216d came from the uniquely identifiable carcass 216c, which may be subsequently determined to come from a uniquely identifiable cow 216b, which grew from the uniquely identifiable calf 216a.

In this regard, the entire event history of the item is made transparent to a user, by linking together various subsequent phases or states of a product with previous uniquely identifiable phases or states. As above, complex label claim validation routines or processes may be performed on later states or phases of an item, to determine whether earlier states or phases of the item met certain conditions. Specifically, a user could enter a unique identifier associated with the hamburger 216n to determine whether, in violation of a label claim, contract requirement, or moral restriction, the calf 216a was ever treated with growth hormones, even if the intermediate phases were not affected by growth hormones.

Since the calf 216a was likely birthed by a cow which was also uniquely identifiable and was also associated with event data, the entry of a unique identifier for the hamburger 216n end product could in practice result in detailed information relating to events that occurred on the calf 216a that was processed into the ground beef 216d, as well as events relating to ancestors of the calf 216a. So, in addition to determining whether growth hormones were used on the calf 216a, to an extent limited only by available event data, it is also possible to determine whether any ancestor cow of the calf 216a was ever treated with growth hormone, thereby improving the confidence of an end-user that the hamburger 216d is hormone-free, as claimed by a label.

In any regard, using the unique identifier of the hamburger 216n, the transaction database server could query and access event data of the hamburger 216n to iteratively access the unique identification information of the ground beef 216d, then the carcass 216c, then the cow 216b, then the calf 216a, then determine based on vaccination or medical event data queried based on the unique identifier of the calf 216a, whether the calf 216a was ever treated with growth hormones. Based on this accessed event information, the label claim, contract requirement, or user's moral restriction could be manually or automatically validated.

If a middle phase or state of the item 216, such as the carcass 216c, does not have a unique identifier, it is still possible for the transaction database server to estimate the unique identifier of a previous phase or state of the missing state or phase of the item, and to make a guess or estimate regarding whether the label claim is valid. If the validity of the label claim is not ascertained with complete certainty, an indication as such may also be output to the user. Using the hamburger example, the transaction database server may determine, based on the unique identity of the carcass 216c that the carcass 216c came from a uniquely identifiable ranch that included uniquely identifiable cows, but the unique identification information of the cow became the carcass 216c may be missing.

By querying nodes using the unique identifier of the ranch itself, that is the unique identifier of the entity that encompasses or includes all possible cows, the transaction database server may determine a probability of each uniquely identifiable cow on the ranch being the cow from which the carcass 216c was harvested and, consequently, the probability that particular, uniquely identifiable cows that eventually grew into the identified cows were the source of the carcass 216c.

Further, the transaction database server cohorts the carcasses, by grouping together those cows that were butchered from the uniquely identifiable calves raised on the ranch, and generates a likelihood or probability that the carcass 216c was butchered from a particular, uniquely identifiable calf. Despite the fact that event data is gathered for multiple or various states or phases of the item 216, the event data for the earliest desired or available phase or state of the item 216 is gathered in real time to receiving the identification information for the latest phase or state of the item.

While FIG. 2 illustrates items 215 and 216 undergoing relatively consecutive processing steps with regard to time and location, thereby altering the form, phase, or state of the item, in other example implementations processing via the various nodes 211 may occur over long periods of time, and may cover great distances. For instance, nodes 211 may be fixed or mobile, may track an item through years or decades of processing, and may be sited on different continents. Furthermore, events may occur to the items that may not be stored by nodes 211 of the supply chain 203.

Although FIG. 2 describes the user device 201, the transaction database server 202, and the nodes 211 as separate devices, this description is merely exemplary. In other implementations, the user device 201, the transaction database server 202 and/or nodes 211 of the supply chain 203 may be combined into one, two or more unified devices, or their functionalities may be combined or blended. For instance, the transaction database 207 may be stored on the user device 201 itself, and the user device 201 may read, generate, or otherwise access data from items in the supply chain using its own bar code scanner, radio frequency identification device (RFID) reader, or other input device.

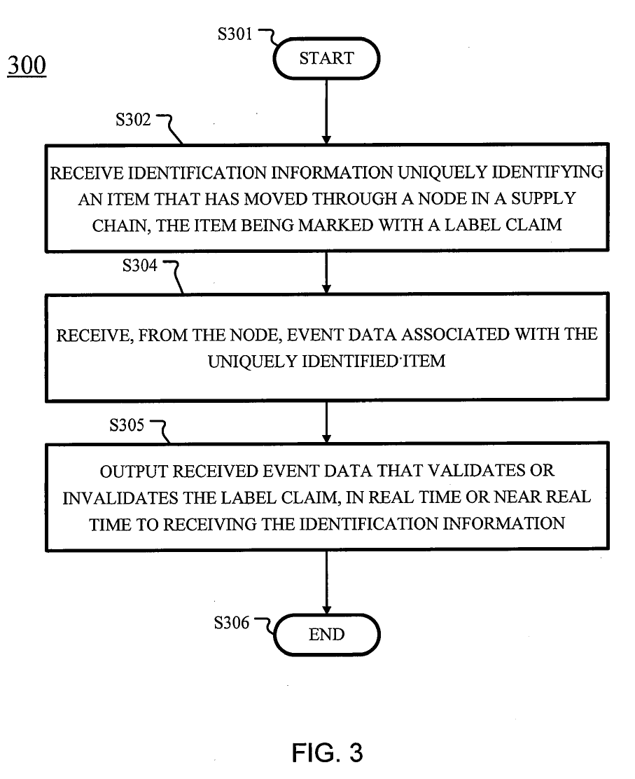

FIG. 3 is a flowchart of a process for performing enhanced validation of a label claim, according to one general implementation. Briefly, a computer-implemented process includes receiving identification information uniquely identifying an item that has moved through a node in a supply chain, the item being marked with a label claim, and receiving, from the node, event data associated with the uniquely identified item. The process also includes outputting received event data that validates or invalidates the label claim, in real time or near real time to receiving the identification information.

According to the present disclosure, a user can enter information that uniquely identifies an item into a user interface, in order to validate a label claim associated with the item, in real time or near real time. Based on the identifying information, nodes in a supply chain are polled or queried for event data or other information regarding the item, and the event data is appropriately reformatted, and automatically compared against the label claim. In addition to outputting the raw event data itself, the user interface outputs indicia to validate or invalidate the label claim, thereby rendering the supply chain for the uniquely identified item more completely transparent.

Using the enhanced approach described herein, it is possible for a consumer to investigate whether a label claim is false or deceiving. For instance, using a handheld computing device, a user may enter information that uniquely identifies an item, and be presented with raw historical event data associated with the item or components of the item, or with an analysis, interpretation or indicia based on the historical event data. Through this presented information, the customer can determine on their own or be shown whether a label claim associated with the item is accurate and/or valid. Through this determination, the customer can alter their purchasing habits, and avoid the unwanted consumption or use of products that do not satisfy their associated label claims.

In further detail, when process 300 begins (S301), identification information uniquely identifying an item that has moved through a node in a supply chain is received, the item being marked with a label claim (S302). The label claim may be an “organic” claim, a “natural” claim, a “no hormone” claim, a point-of-origin claim, an ingredients claim, a vegetarian contents claim, a “cruelty free” claim, a drug claim, a cosmetic claim, a “cage-free” claim, a brand claim, a trademark claim, a compliance claim, or any other claim regarding the character, nature or origin of the item. In addition to validating label claims, the enhanced approach described herein can be used to verify whether contract terms have been satisfied, such as a contract term that requires particular sourcing, freshness, or other characteristic of an item.

Identification information refers to human-readable (e.g. a series of visible characters) or machine-readable data (e.g. a bar code) that distinguishes one item, or collection of items from another. For instance, a Stock Keeping Unit, (SKU), a Universal Product Code (UPC), an interim product identifier, a European Article Number (EAN), a Vehicle Identification Number (VIN), and a Global Trade Item Number (GTIN) are types of unique identifiers that are attached to an item, variant, product line, bundle, service or attachment. The identification information may be inscribed or incorporated onto the item itself, such as the case with a VIN, or the identification information may be located on packaging or an item label that is not an actual part of the item.

The identification information need not be physically or tangibly manifested. For example, the user may obtain identification information for a product via a telephone call with a customer service representative, or using an on-line database. For instance, a manufacturer may wish to limit a consumer's access to the event data or the label validation information, and may provide the uniquely identifying information to the user only if the user calls a customer service representative with a complaint or request for information, and provides a time, date and location of purchase of the item. As indicated above, however, in many cases the identification information will be physically affixed to the item or packaging of the item, and the label claim may be physically affixed to the item or packaging of the item.

The identification information may be associated with a single product or a group of products, or multiple, discrete identifying information can be received to identify a group of products. For instance, the identification information may represent batch identification information identifying a palette of items, or a container (such as a boxcar) of items, where the batch identification information may be mapped to or associated with the individual identification information identifying the individual items within the palette or container. Alternatively, the multiple individual identification information identifying individual items within a palette or container can be received instead of or in addition to the batch identification information that represents the group of individual items. Such functionality allows batches of items to be processed and validated at once.

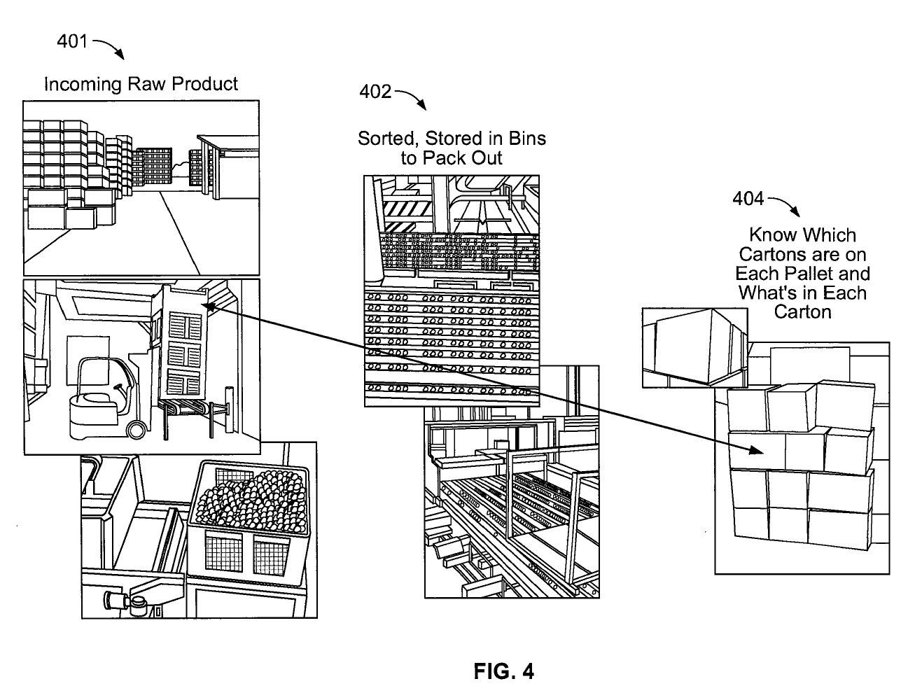

Referring ahead briefly, FIG. 4 provides a brief conceptual overview of a process for assigning a unique identifier to an item in a supply chain. An item, a group of items, or components of an item (collectively, “raw product”) is received at an unique identifier assignment system (401). The unique identifier assignment system may or may not be within the supply chain itself, and thus may or may not perform processing functions aside from the assignment of the unique identifier.

Once received, the raw product is sorted, assigned a unique identification number, and in some cases, collectively stored (402). The raw product may be collectively stored before the unique identifier is assigned, such as in the case of fruit sold by the carton, or the raw product may be collectively stored after the unique identifier is assigned, such as in the case of a consumer electronic item that is palletized after a serial number is assigned. In any case, once the unique identifier has been assigned and the raw product has been stored collectively, it is possible to determine which items are stored with each other, and what items are in each storage unit (404). Through such an approach, each item in each carton or pallet may be linked to the origin of manufacture of the item.

In any regard, the unique identifier assignment process itself may generate event data that is associated with the item and stored. For instance, a unique identifier assignment event may include event data that describes the origin of the item, components of the item, the time or date when the unique identifier was assigned, unique identifiers that are stored or “cohorted” with the uniquely identified items, the unit of storage, the destination of the item after the occurrence of the unique identifier assignment event, or other data. Table 2, below, provides exemplary event data associated with a particular identifier and an exemplary unique identifier assignment event.

TABLE 2
Event Data Associated With A Particular Unique Identifier

| Event Name | Data | Data Type |
|---|---|---|
| IDENTIFIER ASSIGNMENT | Mar. 3, 2007 | Date |
| DATE | | |
| ORIGIN | Freshfield Farms | Text |
| BATCH NUMBER | 1138 | Number |
| DESTINATION | Processing Facility #11 | Text |
| DEPARTURE DATE | Mar. 4, 2007 | Date |
| DEPARTURE TIME | 14:37:03 | Time |
| ASSIGNED CARTON | 3742 | Number |
| ASSIGNED PALLET | 1263 | Number |
| ITEM TYPE | Oranges, Delano | Text |

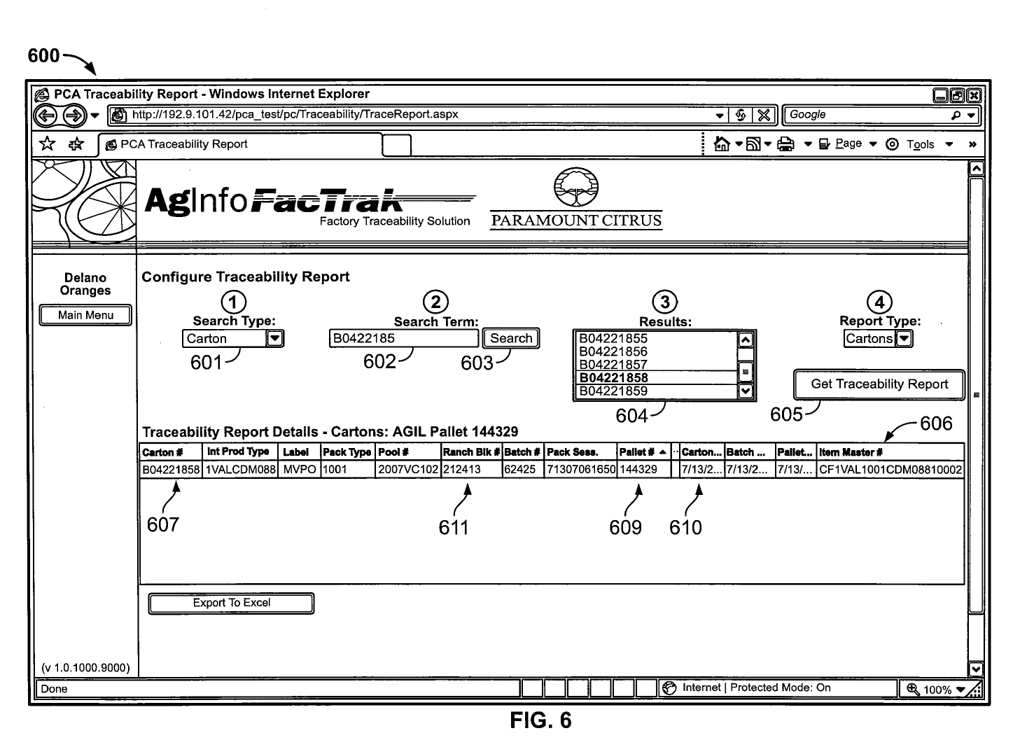

Receiving the identification information may further include generating a user interface, and receiving the identification information from a user via the generated user interface. FIGS. 5 and 6 illustrate exemplary user interfaces 500 and 600, respectively, for entering identification information and outputting event information.

The user interface 500 includes a search type control 501, which in this case is a drop-down control, that allows a user to select the type of identifier to search by. The user interface 500 also includes a search term control 502, which in this case is a text field, that allows the user to select which of the selected types they would like to view, as well as a search button control that executes the search. In FIG. 5, for example, by selecting the search button control 503, the user indicates that they wish to search by pallet identifier, and that they wish to view those pallets identified by the number “144329.”

The results of the search are shown in the results window 504. Upon selecting identification information for a particular result and then selecting the “Get Traceability Report” button 505, event data matching the selected identification information is output in a window 506. In FIG. 5, for example, the event data output in the window 506 indicates the carton numbers (column 507) that match the selected pallet identification number (column 509).

As discussed in more detail below, the event data output in the window 506 may be automatically or manually analyzed to determine whether a label claim is valid or accurate, in real time or near real time. For instance, if a produce wholesaler receives the pallet of oranges identified by identification number “144329” and searches for associated event data using the user interface 500, the information in column 510 may be used to refute a label claim (or a contract requirement) that the oranges were packaged within the last three days.

The information in column 511, which identifies a source ranch of the items contained in the selected pallet, may be used by a user to refute a label claim (or a contract requirement) that the oranges were grown or otherwise sourced at a particular farm, or a particular plot of a farm. The identification information for a carton of oranges can thus be used by a web-based system to obtain the traceability information on the exact product SKU, every pallet that the carton has ever been placed upon, and every ranch block number that provided one or more oranges contained within the carton.

In any regard, since the user interface 500 uses codes to identify various data elements, and displays data fields that a typical consumer many not be interested in viewing, it may be that the exemplary user interface 500 may be of the kind that is best suited for a sophisticated user, such as a wholesaler or commercial client. As described in more detail herein, other user interfaces (such as user interfaces 106 and 121) may be designed to provide more focused event data, to offer fewer options, or to provide an automatic analysis of the label claim, and may thus be better suited for a consumer or other end user.

FIG. 6 illustrates a user interface 600 which, unlike user interface 500, performs a traceability search on an item based on a unique carton identifier, instead of a unique pallet identifier. The user interface 600 includes a search type control 601, which in this case is a drop-down control, that allows a user to select the type of identifier to search by. The user interface 600 also includes a text field search term control 602 that allows the user to select which of the selected types they would like to view, as well as a search button control that executes the search. In FIG. 6, for example, by selecting the search button control 603, the user indicates that they wish to search by carton identifier, and that they wish to view those cartons identified by the number “B0442185.”

The results of the search are shown in the results window 604. Upon selecting identification information for a particular result in the results window 604 and then selecting the “Get Traceability Report” button 605, event data matching the selected identification information is output in a window 606. In FIG. 6, for example, the event data output in the window 606 indicates the identified carton number (column 607), and a pallet identifier that identifies a pallet upon which the identified carton was packed (column 609).

The event data output in the window 606 may be automatically or manually analyzed to determine whether a label claim is valid or accurate, in real time or near real time to entering the identifier into the user interface. For instance, if a produce wholesaler receives the carton of oranges identified by identification number “B0442185” and searches for associated event data using the user interface 600, the information in column 610 may be used to refute a label claim (or a contract requirement) that the oranges were packaged within the last three days, and the information in column 611, which identifies a source ranch of the items contained in the selected pallet, may be used by a user to refute a label claim (or a contract requirement) that the oranges were grown or otherwise sourced at a particular farm, or a particular plot of a farm.

The identification information may be received manually, such as by using a keyboard, mouse, or voice input, or automatically using a radio frequency identification device (RFID) reader, a barcode scanner, or any other mechanisms that effects the efficient input of identification information.

Returning now to FIG. 3, event data associated with the uniquely identified item is received from the node (S304). The unique identification number is used as the basis for a query of the nodes in the supply chain, in order to receive all or a portion of the event data relating to events experienced by the identified item during its processing and movement through the supply chain. In a simple example, a query is sent to all nodes that are in communication with a transaction database server, requesting that all event databases be searched for information relating to the entered identification information.

Based on receiving this query, the nodes may access the event databases using a look-up table, index, or other mechanism, and output event data associated with the identification information. This output event data is then sent back to the transaction database server for reformatting, collation, processing, analysis, and/or further transmission or output. Event data associated with the uniquely identified item may be received from a second, third, or Nth node, and the event data received from the nodes may be reformatted.

In additional implementations, the transaction database server may store information indicating that the item has definitely passed through, or definitely not passed through certain nodes. This would apply in a situation where, upon processing an item, a node sends a message to the transaction database server that particular items have been processed and that event data has been stored at the node, or has not yet been processed and that event data is not yet stored.

In this situation, the transaction database server may not query each node with which the server is in communication, but may rather automatically determine which servers are known to store event data, or which servers are known to store event data relevant to the label claim validation, and query selected nodes based on this automatic determination. For instance, if the transaction database server stores information that indicates that a certain farm stores information for a produce item relating to a seed planting event and a produce harvesting event, the transaction database may query or poll nodes associated with that farm to determine the source or origin of the produce item, and may not query or poll nodes associated with other farms in an effort to receive event data relating to seed planting and produce harvesting events.

In an additional example, the transaction database server may store information for each node relating to the types of hardware or software used by the nodes, and may format queries appropriately, or may generate queries that will cause the nodes to format data according to a preferred format of the transaction database server. As it is expected that event data will be stored on a large variety of systems, including systems that implement legacy, obsolete, or proprietary query engines, the ability to effectively communicate with these systems and to gather event data across multiple systems is beneficial. In this regard, a data collection interface is established between the node and a transaction database, the data collection interface allowing the transaction database to receive the event data associated with the uniquely identified item from the node.

In a further example, the transaction database server may itself store event data, such as the case where nodes send indicia to the transaction database server that an item has been processed, such that the identification information is received before or after the event data is received from the node. In these instances, the transaction database server may avoid querying the individual nodes, to avoid the duplication of event data and to reduce computational expense. If no response is received by the query, the transaction database may default to a condition in which it is assumed that no event data is stored at the queried node, or the node may be re-queried. A historical query response rate may be used to aid this determination, such that a node that affirmatively responds to a majority of queries, including queries that result in an indication that no event data is stored, may be re-queried if no response is received to an initial query.

In an additional example, the transaction database server may merely polls those nodes in the supply chain, or types of nodes in the supply chain, that would be relevant to the label claim validation. For instance, if the label claim associated with processed meat relates to process that the animal was slaughtered, such as a “Kosher” or a “Halal” label claim, the transaction database server may merely poll nodes associated with slaughterhouses for event data relating to the identified processed meat item. In this regard, the transaction database server may choose to not query other nodes, such as nodes that store birthing, vaccination, or transportation event data but not slaughtering event data that would confirm or otherwise validate the “Kosher” or “Halal” label claim.

The event data received from the queried nodes may relate to any event data stored at the node, to event data relating to the identified item only, to a movement of or a particular supply chain processing of the uniquely identified item at the node, to event data that was generated within a particular time period, only to event data that is relevant to the validation of the label claim, or the event data may relate to other factors. The event data itself may represent an event identification number attribute, a type attribute, a nomenclature attribute, a quantity attribute, a unit-of measurement attribute, a parent event identification number attribute, or a child event identification number attribute, and may be associated with a vaccination event, a harvesting event, a birthing event, or a transportation event, a treatment event, a planting event, a location event, a containering event, or a cohorting event.

Received event data that validates or invalidates the label claim is output in real time or near real time to receiving the identification information (S305), and the process 300 ends (S306). As illustrated above with respect to FIGS. 5 and 6, the received event data that validates or invalidates the label claim may include all of the event data that was received at the transaction database server from the queried nodes, or a subset of all of the received event data.

Continuing with the example described above, for instance, if the label claim is a “kosher” or “halal” label claim on processed meat and the transaction database server receives event data from numerous nodes including nodes that store event data unrelated to the slaughtering process, the transaction database server may filter the received event data, and merely output germane event data, such as event data received from a slaughterhouse node, or event data that specifically validates or invalidates the label claim.

As the transaction database server is configured, adapted, or is operable to receive data from multiple nodes or data sources that may each use their own language, specification or data format, the transaction database server may effect the output of received event data received from the various nodes by establishing a data conversion interface between the output device and the transaction database, the data conversion interface allowing the output of the received event data from the transaction database using the output device.

Instead of or in addition to outputting received event data that validates or invalidates the label claim, the transaction database server may automatically validate or invalidate the label claim itself, and output an indicia of the validity or invalidity of the label claim itself. The indicia may include an explicit statement, such as “The Label Claim Has Been Validated,” or “The Item Has Been Made In the U.S.A.” Alternatively, the label claim may be validated inferentially, such as were information or indicia is only provided when the label claim is valid or invalid, or where the probability that the label claim is valid or invalid exceeds or does not exceed a threshold.

In any case, a user may input the label claim to validate manually, or the transaction database server may automatically determine which label claims to automatically validate or invalidate. For instance, the transaction database server may determine the type of item associated with the unique identifier, and validate all or some of the label claims that are associated with that type of item.

Specifically, the transaction database server may determine that a first item is a package of ground beef, and automatically determine whether the beef is “Hormone Free” and “Halal” based on the identification information of the first item and the received event data associated with the identification information, but not attempt to automatically determine that the beef is “Perfume-free,” “Certified Child-Labor Free,” or “Not Tested On Animals.” Similarly, the transaction database server may automatically determine that a second item is a consumer electronic, and automatically determine whether the consumer electronic is “Made in the U.S.A.” or “UL Listed” based on the identification information of the second item and the received event data associated with the identification, but not attempt to automatically determine that the consumer electronic is “free range.”

Such a determination may be performed by storing a look-up table, database, or other mechanisms at the transaction database server that associates identification information with item types, and associates item types with appropriate label claims. Table 3 illustrates one such exemplary table, where “#” represents any number, and “A” represents any alphabetical character:

TABLE 3
Sample Identification Information, Item Types, and
Appropriate Label Claims

| Identification | | Appropriate |
|---|---|---|
| Information Format | Item Type | Label Claims |
| A-##### | Food, Ground Beef | No Hormone |
| (Range: 0-49999) | | Kosher |
| | | Vegetarian |
| | | Montana-Raised |
| | | Fresh Never Frozen |
| A-##### | Food, Ground Turkey | No Hormone |
| (Range: 5000-9999) | | Kosher |
| | | Vegetarian |
| | | Cage-Free |
| AAA-AA-AAAA | Consumer Electronics | No Child Labor |
| | | UL Listed |
| | | Made In China |
| #A-###-AAA | Clothing | No Perfumes Or Dyes |
| | | No Child Labor |
| | | Made In India |
| | | 100% Cashmere |
| A########A | Pharmaceutical | Not Tested On Animals |
| | | Natural Ingredients |
| | | Generic |
| | | Made In The U.S.A. |

Additionally, the transaction database server may automatically validate or invalidate a label claim based upon user preferences, based upon a user profile, or based on common or historical validation patterns determined through time. For instance, if the user is vegetarian the transaction database server may automatically check all items, or all food items, to determine whether they are vegetarian, based on the user indicating a preference for this type of validation to occur for all validations, or for validations of food products. Such an approach would save the user from having to input that they wished to check for meat content on each and every validation where the item is a food product.

Similarly, based on accessing a user profile, the transaction database server may determine that the user fits into a class, category or type of user that would be interested in running particular validations for all items, or types of items, with or without an explicit label claim. Using this user profile information, the transaction database server may access a database that associates the class, category or type of user with validation preferences with that class, category or type of user.

For instance, a user profile may determine that the user practices a certain religion that exercises dietary restrictions, where all food items are automatically validated to determine whether the dietary restriction is satisfied, based on received event data. Using this approach, even if an item claims to be in compliance with the dietary restriction, a user may achieve piece-of-mind by quickly determining, based on viewing the actual event data associated with the identified item, whether their personal commitments and moral obligations have been met.

In the case where multiple identification is received, or where batch identification information is received representing a multitude of items (such as a container of uniquely identifiable items), a label claim may be invalidated for the batch as a whole, or for each individual item within the batch. The automatic validation may express the validity of a particular claim for each item within a batch individually, or the claim validity may be expressed as a percentage of items within the batch for which the claim is valid or invalid, for instance describing a compliance percentage. Furthermore, the automatic validation may output those items within the batch for which the claim is valid or invalid.

Identification information uniquely identifying a component of the uniquely identified item may be received based on outputting the received event data. Component event data associated with the component may be received from a second node on the supply chain, and received component event data that validates or invalidates the label claim may be output, in real time or near real time to receiving the identification information uniquely identifying the component.

The item may be transformed from a first product to a second product at the node, and the output received event data that validates the label claim may further include event data associated with the first product and event data associated with the second product. The first product may be a living product, such as a living animal, fruit or vegetable, where the second product is a non-living product, such as a meat product or a harvested fruit or vegetable.

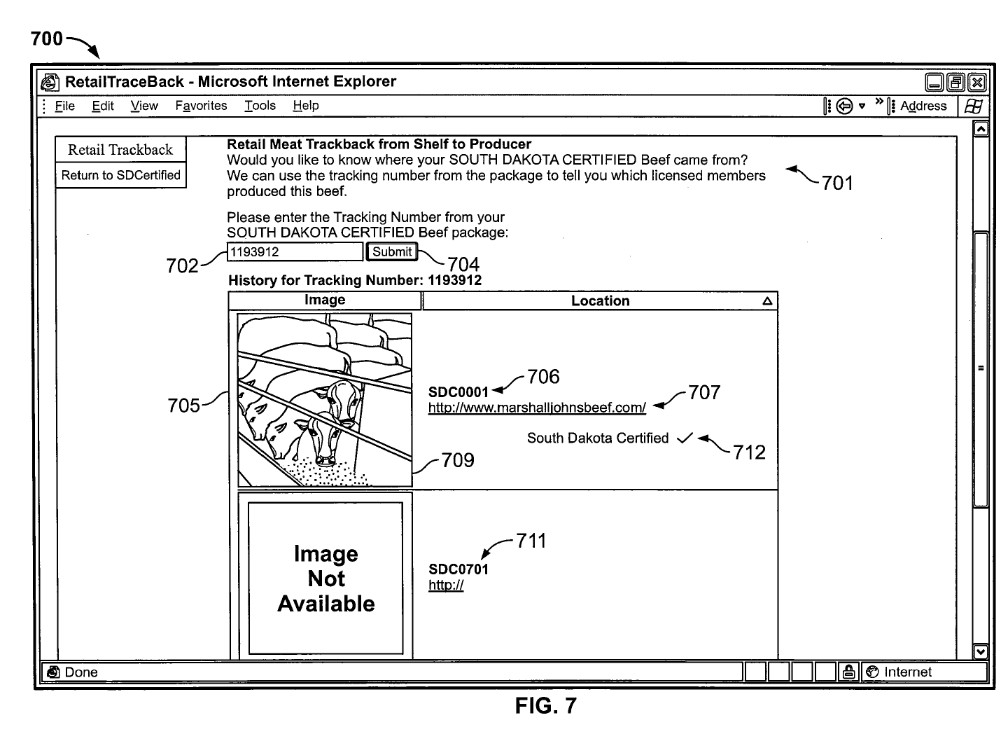

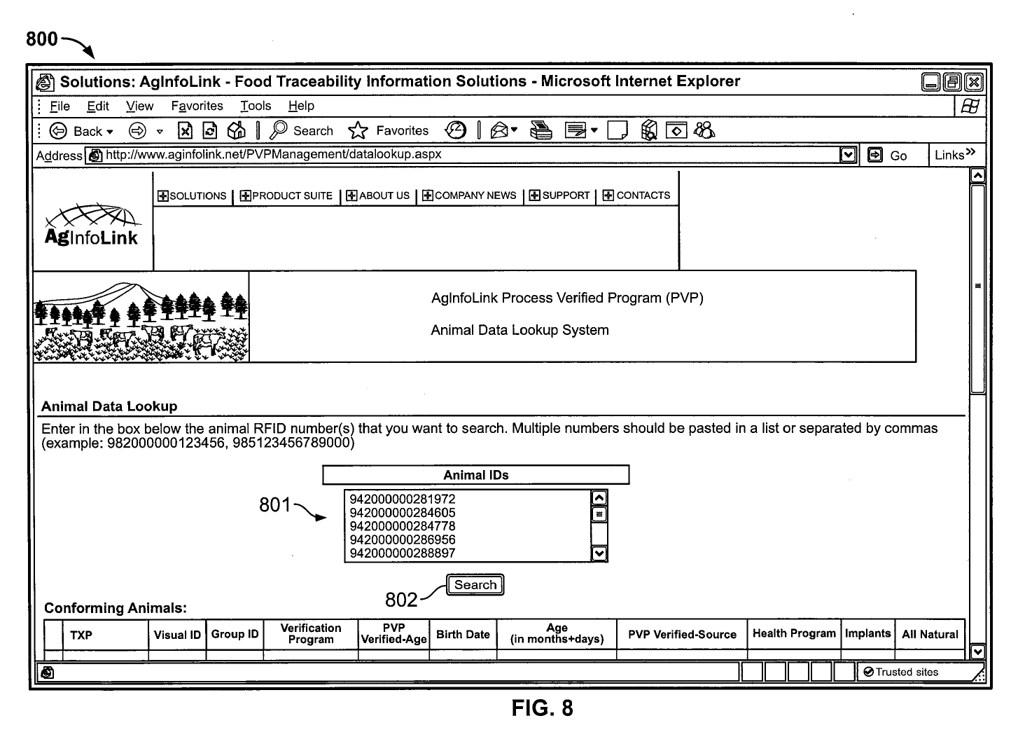

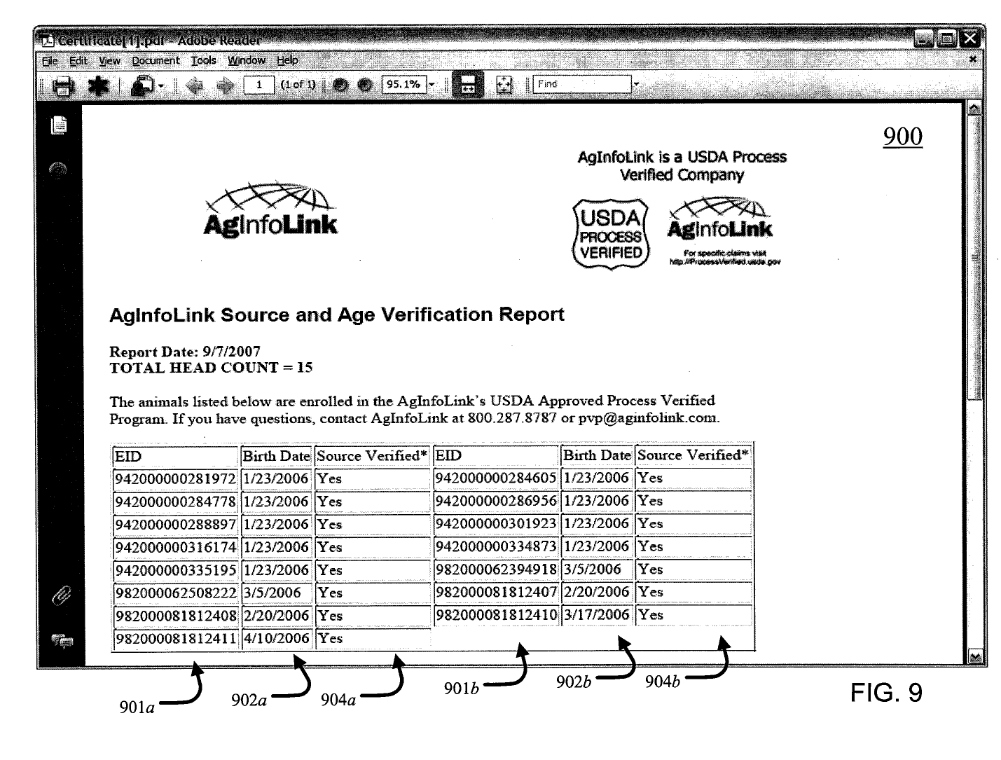

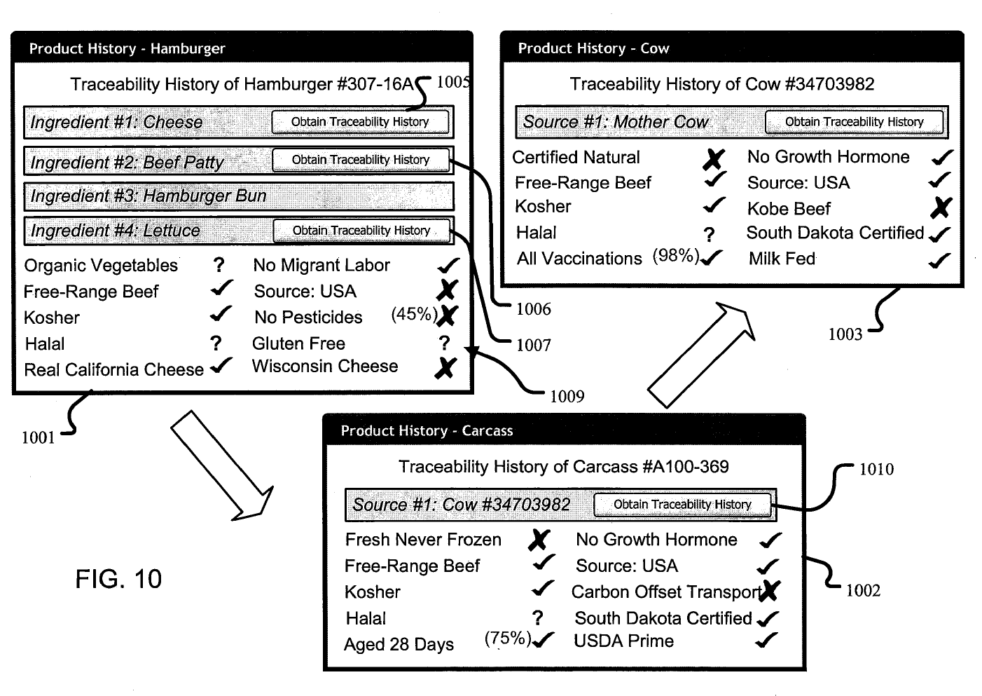

FIGS. 7 to 10 illustrate exemplary user interfaces for entering identification information and outputting event information that validates a label claim. Briefly, FIG. 7 shows a web-based user interface 700 that, by providing fewer options and by outputting event data in a user friendly manner, is oriented for an end-user or consumer. Furthermore, FIGS. 8 and 9 show web-based user interfaces 800 and 900 for validating source and age of cattle, and FIG. 10 illustrates user interfaces 1001 to 1003, which automatically and iteratively or recursively validates label claims for an item in a supply chain through a multiple phases or states.

In FIG. 7, the user interface 700 includes a text region 701 that describes the purpose or goal of the label claim validation, and instructs the user how to use the enhanced label claim validation application. In particular, the text region 701 tells the user that the user interface 700 can be used to confirm that a beef product is truly “South Dakota Certified” Beef.

In confirming that the beef purchased by the consumer satisfies this certification, the enhanced label claim validation application does not merely access a local lookup table to cross-reference an input identifier of the beef; rather the application actively queries or polls at least one node within the supply chain of the identified beef item, retrieves event data associated with the beef item, applies rules against the retrieved event data, and displays the event data or an interpretation of the event data to the user in real time or near real time to receiving the identification information based on applying the rules. In doing so, the text region 701 also instructs the user to enter a tracking number, or unique identification number, of a beef item into text field 702.

The user may locate the tracking number from the packaging, sales literature, advertising or other documentation associated with the beef item, of verbally from a sales person or customer service personnel. Upon entering the tracking number (“1193912”) into the text field and selecting the submit form control 704, the enhanced label claim validation application queries nodes in a supply chain for event data, using the entered tracking number, receives event data associated with the tracking number, and prepares the event data for output to the user. Output event data may be displayed by completely refreshing a web page that includes user interface 700, or the user interface 700 may include Asynchronous Java and XML (AJAX) or other controls that allow the user interface 700 to be updated without refreshing the web page.

In this example, the event data accessed at the transaction database in response to the tracking number query indicates that the beef item identified with tracking number 1193912 was processed in at least two source nodes, “SDC0001,” and “SDC0701,” which a lookup table or other mechanism on the transaction database server can automatically identify as “Marshall John Beef,” and another unidentified ranch. Since user interface 700 is intended for use by a customer, it may be designed only to provide sufficient information to validate the label claim, and may not be designed, for example, to output all received event data, or to allow the user to recursively or iteratively track the event history of previous phases or states, or components of the item.

In this regard, in event data output window 705, the user interface 700 displays the identifier 706 of the first source node of the item and a URL 707 of the first source node. Since the received event data from this first source node includes a picture or image 709 of the actual cattle that was eventually processed into the beef item, the image 709 is also displayed in the user interface 700. Similarly, the user interface 700 displays the identifier 710 of the second source node of the item, but does not display a URL or an image because that information is not available, not identifiable, or superfluous.

Using event data or interpreted event data output in the user interface 700, the user may manually validate the label claim that the beef item is “South Dakota Certified™” beef by selecting the URL 707, and determining that “Marshall Johns Beef” sells beef that satisfies this certification. Furthermore, since the enhanced label claim validation application can use rules to automatically validate this label claim by cross-referencing the identifier 706 against a database of sources of “South Dakota Certified” beef, or by cross-referencing the address of the first source node to determine if it is located in South Dakota, and output an interpretation or indicia of this validation.

In user interface 700, for example, indicia 712 indicates that the first source node satisfies the “South Dakota Certified™” beef certification. The output of the indicia 712 occurs in real time or near real time to the selection of the submit form control 704. Each meat item has a label placed on it that can be traced back to the animal from which it came, for example by querying the carcass information. A consumer can access a web-based lookup system to query the animal movement system, to identify all of the previous owners of that animal.

User interfaces 800 and 900 in FIGS. 8 and 9, respectively, are used in a similar manner to validate or verify the source and age of cattle. Specifically, animal RFID numbers that uniquely identify cattle are entered into open interaction element 801, and a form submission control 802 is selected. Based on the selection of this control, the enhanced label claim validation application queries nodes of a supply chain that processes the animals identified by the input RFID numbers, and outputs via user interface 900 the animal RFID numbers (columns 901a and 901b), the birth date of the identified animals (columns 902a and 902b), and an indicia that validates or verifies the source of the identified animals against predefined or pre-selected criteria (columns 904a and 904b), or validates or verifies that the identified animal has auditable source information.

In order for an animal to comply with the age and source information, each animal must have auditable information on both its age, and where the animal originated. Knowing the animal's age is very important for purposes of beef export, knowing the animal's source is important for purposes of disease traceability, etc. Interested parties can use a public on-line web site to enter the unique identifier on the animal, and get a United States Department of Agriculture approved certificate the certifies the animal is of a specific age, and that there is an auditable record of where that animal originated.

As noted above, FIG. 10 illustrates user interfaces 1001 to 1003, that automatically and iteratively or recursively validates label claims for an item in a supply chain through a multiple phases or states. Using user interfaces 1001 to 1003, label claims to validate are automatically selected based on the type of item being checked.

In more detail, user interface 1001 is generated and output as a result of a user entering identification information (“307-16A”) for a hamburger, and further as a result of a transaction database server querying nodes of a supply chain for historical event data relating to the hamburger and/or components of the hamburger. Such identification information may be found, for example, on the packaging of a frozen hamburger, or on the packaging or receipt of a freshly cooked hamburger. Notably, the user is not required to indicate which label claims they would like to validate or verify.

Based on received event data, the user interface 1001 displays the components or ingredients of the hamburger, including cheese, beef patty, hamburger bun, and lettuce. As described in further detail below, since the received event information indicates that the cheese, beef patty, and lettuce (but not the hamburger bun) are each associated with a unique identifier, controls 1005 to 1007 are displayed in conjunction with the cheese, beef patty, and lettuce, respectively, to allow a user to validate label claims against these items as well.

Having determined that the components of the hamburger item include cheese, a beef patty, a hamburger bun, and lettuce, the transaction database server accesses a database that associates item types with appropriate label claims, and generates a list of label claims that match, or would be appropriate for, the components of the hamburger item, as well as the hamburger item as a whole. For instance, appropriate label claims for the cheese component include “Real California Cheese” or “Wisconsin Cheese,” label claims for the beef patty component include “Free-Range Beef,” label claims for the hamburger bun component include “Gluten Free,” and label claims for the lettuce component include “No Pesticides” and “Organic Vegetables.”

Furthermore, label claims for the hamburger item as a whole include “Kosher,” “Halal,” “No Migrant Labor,” and “Source: USA,” since the result of a label claim verification for these label claims should depend on the results of individual label claim verifications for each component. Since space is limited on the user interface 1001, the transaction database server may select, if a large number of label claims are determined to be appropriate, random label claims, a certain number of label claims per each component, a user's explicitly or implicitly-determined preferred label claims, or label claims based on any number of other factors. Where the enhanced label claim validation application determines a probability (versus a certainty or near certainty) that the label claim is valid or invalid, the probability is shown within the user interface as a percentage.

The transaction database server performs an automatic label claim validation for each of the label claims based on receiving event data in real time or in near real time to entering the identification information for the hamburger item, and outputs indicia (in the form of a check mark, a red ‘X,’ or a question mark) indicating the validity of each appropriate label claim in window 1009. Notably, the “Source: USA” label claim is considered invalid if any of the components of the hamburger item, such as the lettuce, are sourced from outside the United States. Using simplified output indicia, and by avoiding the output of raw event data itself, the user interface 1001 is easily interpretable and navigable by even the most novice computer user.

Having reviewed the traceability history of the hamburger item as a whole, the user may wish to review the traceability history of the carcass that produced the beef patty itself, using the identification information (“A100-369”) of the carcass. This can be accomplished by selecting control 1006. In one implementation, the transaction database server pre-fetches event information for all generations of all components of an item being reviewed, while in another implementation only historical event data for an item being viewed is received upon the receipt of identification information, or historical event data is received for an item and N previous states or phases of an item.

Upon detecting the selection of the control 1006, for example, the transaction database server may actively query nodes for event data that relates to a uniquely identified carcass that produced the beef patty, or the transaction database server may merely access the transaction database to locate event data that has already been queried based on the label claim validation of the hamburger item. Similarly, the transaction database server may determine appropriate label claims to validate, and may even proceed to validate these appropriate label claims, prior to the selection of a component or previous state or phase of an item.

In any case, as above, the transaction database server dynamically or automatically determines appropriate label claims to validate based on a detected or determined type of the beef carcass item. For instance, the user interface 1002 now includes other beef-related label claims that were not shown in the user interface 1001, such as a “Fresh Never Frozen” label claim, or a “Carbon Offset Transportation” label claim which purports to have offset the carbon involved in the transportation of the carcass. Since the user is specifically requesting the validation of a label claim relating to beef, the user interface 1002 does not reference label claims that are not associated with beef, such as “Organic Vegetables,” or “Real California Cheese.” As above, the enhanced label claim validation application validates the automatically selected label claims, and places determinative indicia adjacent to the label claims.

Notably, although user interface 1001 indicates that the label claim “Source: USA” is invalid, the user interface 1001 indicates that this same label claim is valid. This inconsistency may occur because the validation of the label claim in user interface 1001 takes all of the components of an item into effect to validate the label claim of the item as a whole, while the user interface 1002 validates the label claim of the selected component alone. In other words, if the lettuce component may serve to invalidate a “Source: USA” label claim for the hamburger item as a whole in user interface 1001, while this same label claim can be validated with respect to the carcass alone in user interface 1001 because the lettuce is not a component of the carcass itself.

Since the carcass is sourced from a uniquely identifiable cow (“#34703982”), the user may select control 1010 to view the traceability history of the cow and to validate label claims associated therewith. Similar to above, the enhanced label claim validation application selects appropriate label claims to validate, and performs a validation of the label claims with respect to the uniquely identifiable cow by querying nodes of a supply chain or accessing event data stored as a result of a previously issued query. As shown in user interface 1003, since the event data of the uniquely identifiable cow includes a unique identifier of a parent cow of the uniquely identifiable cow, the user may continue to recursively or iteratively investigate label claims up through the supply chain.

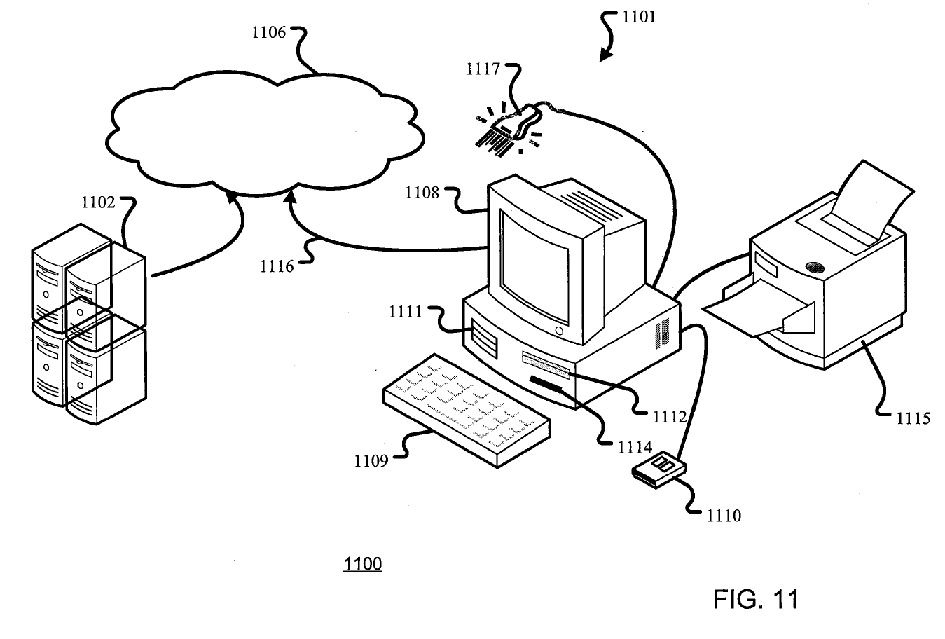

FIG. 11 depicts the exterior appearance of a an exemplary system including a user device and transaction database server. Briefly, the system 1100 includes a user device 1101 and a transaction database server 1102 that includes a transaction database. As described in further detail, below, the system 1100 includes, inter alia, an interface that receives identification information uniquely identifying an item that has moved through a node in a supply chain, the item being marked with a label claim, that receives, from the node, event data associated with the uniquely identified item, and that outputs received event data that validates or invalidates the label claim, in real time or near real time to receiving the identification information.

In more detail, the hardware environment of the user device 1101 includes a display monitor 1108 for displaying text and images to a user, a keyboard 1109 for entering text data and user commands into the user device 1101, a mouse 1110 for pointing, selecting and adjusting objects displayed on the display monitor 1108, a fixed disk drive 1111, a removable disk drive 1112, a tape drive 1114, a hardcopy output device 1115, a computer network connection 1116, and a reader 1117.

The display monitor 1108 displays graphics, images, and text that comprise the display for the software applications used by the user device 1101, as well as the operating system programs necessary to operate the user device 1101. A user uses the keyboard 1109 to enter commands and data to operate and control the computer operating system programs, the web browser, and/or the enhanced label claim validation application. The user uses the mouse 1110 to select and adjust graphics and text objects displayed on the display monitor 1108 as part of the interaction with and control of the user device 1101 and applications running on the user device 1101. The mouse 1110 is any type of pointing device, and may be a joystick, a trackball, a touch-pad, or other pointing device.

The reader 1117 allows the user device 1101 to automatically capture identification information, and may be a RFID reader, a bar code scanner, a digital camera, a digital video camera, a microphone or other digital input device. Software used to provide for the enhanced label claim validation application is stored locally on computer readable memory media, such as the fixed disk drive 1111.

In a further implementation, the fixed disk drive 1111 itself may include a number of physical drive units, such as a redundant array of independent disks (“RAID”), or may be a disk drive farm or a disk array that is physically located in a separate computing unit. Such computer readable memory media allow the user device 1101 to access computer-executable process steps, application programs and the like, stored on removable and non-removable memory media.

The wireless or wireline computer network connection 1116 may be a modem connection, a local-area network (“LAN”) connection including the Ethernet, or a broadband wide-area network (“WAN”) connection such as a digital subscriber line (“DSL”), cable high-speed internet connection, dial-up connection, T-1 line, T-3 line, fiber optic connection, or satellite connection. The network 1106 may be one or more of a LAN network, a corporate or government WAN network, the Internet, or other network.

The computer network connection 1116 uses a wireline or wireless connector. Example wireless connectors include, for example, an INFRARED DATA ASSOCIATION® (“IrDA®”) wireless connector, an optical wireless connector, an INSTITUTE OF ELECTRICAL AND ELECTRONICS ENGINEERS® (“IEEE®”) Standard 802.11 wireless connector, a BLUETOOTH® wireless connector, a near field communications (“NFC”) connector, an orthogonal frequency division multiplexing (“OFDM”) ultra wide band (“UWB”) wireless connector, a time-modulated, ultra wide band (“TM-UWB”) wireless connector, or other wireless connector. Example wireline connectors include, for example, a IEEE®-1394 FIREWIRE® connector, a Universal Serial Bus (“USB”) connector, a serial port connector, a parallel port connector, or other wireline connector.

The removable disk drive 1112 is a removable storage device that is used to off-load data from the user device 1101 or upload data onto the user device 1101. The removable disk drive 1112 may be a floppy disk drive, an IOMEGA® ZIP® drive, a compact disk-read only memory (“CD-ROM”) drive, a CD-Recordable drive (“CD-R”), a CD-Rewritable drive (“CD-RW”), flash memory, a USB flash drive, an external hard disk drive, thumb drive, pen drive, key drive, a High-Density Digital Versatile Disc (“HD-DVD”) optical disc drive, a Blu-Ray optical disc drive, a Holographic Digital Data Storage (“HDDS”) optical disc drive, or any one of the various recordable or rewritable digital versatile disc (“DVD”) drives such as the DVD-Recordable (“DVD-R” or “DVD+R”), DVD-Rewritable (“DVD-RW” or “DVD+RW”), or DVD-RAM. Operating system programs, applications, and various data files, are stored on disks, which are stored on the fixed disk drive 1111 or on removable media for the removable disk drive 1112.

The tape drive 1114 is a tape storage device that is used to off-load data from the user device 1101 or to upload data onto the user device 1101. The tape drive 1114 may be a quarter-inch cartridge (“QIC”), 4 mm digital audio tape (“DAT”), 8 mm digital linear tape (“DLT”) drive, or other type of tape.

The hardcopy output device 1115 provides an output function for the operating system programs and applications. The hardcopy output device 1115 may be a printer or any output device that produces tangible output objects, including textual or image data or graphical representations of textual or image data. While the hardcopy output device 1115 is depicted as being directly connected to the user device 1101, it need not be. For instance, the hardcopy output device 1115 may be connected to device 1101 via a network interface, such as a wireline or wireless network.

Furthermore, although the user device 1101 is illustrated in FIG. 14 as a desktop PC, in further implementations the user device 1101 may be a laptop, a workstation, a midrange computer, a mainframe, a set top box, an embedded system, telephone, a handheld or tablet computer, a PDA, or other type of computer.

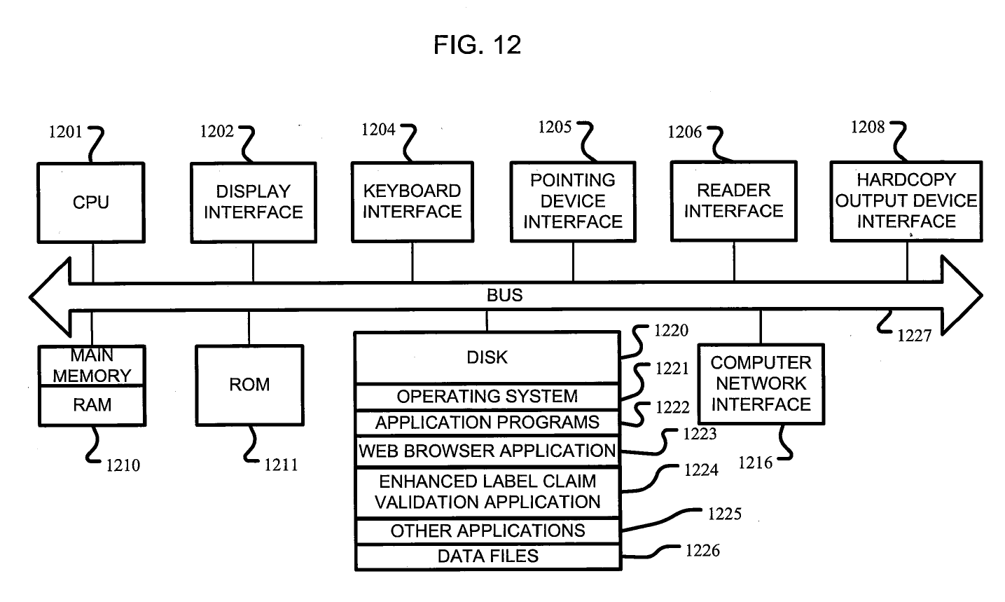

FIG. 12 illustrates the internal architecture of the user device of FIG. 11. The computing environment includes a computer central processing unit (“CPU”) 1201 where the computer instructions that comprise an operating system or an application are processed; a display interface 1202 which provides a communication interface and processing functions for rendering graphics, images, and texts on the display monitor 1108; a keyboard interface 1204 which provides a communication interface to the keyboard 1109; a pointing device interface 1205 which provides a communication interface to the mouse 1110 or an equivalent pointing device; a reader interface 1206 which provides a communication interface to the video and audio detector 1117; a hardcopy output device interface 1208 which provides a communication interface to the hardcopy output device 1115; a random access memory (“RAM”) 1210 where computer instructions and data are stored in a volatile memory device for processing by the computer CPU 1201; a read-only memory (“ROM”) 1211 where invariant low-level systems code or data for basic system functions such as basic input and output (“I/O”), startup, or reception of keystrokes from the keyboard 1109 are stored in a non-volatile memory device; a storage 1220 or other suitable type of memory (e.g. such as random-access memory (“RAM”), read-only memory (“ROM”), programmable read-only memory (“PROM”), erasable programmable read-only memory (“EPROM”), electrically erasable programmable read-only memory (“EEPROM”), magnetic disks, optical disks, floppy disks, hard disks, removable cartridges, flash drives), where the files that comprise an operating system 1221, application programs 1222 (including web browser application 1223, enhanced label claim validation application 1224, and other applications 1225 as necessary) and data files 1226 are stored; and a computer network interface 1216 which provides a communication interface to the network 1106 over the computer network connection 1116. The constituent devices and the computer CPU 1201 communicate with each other over the computer bus 1227.

Briefly, a computer program product is tangibly embodied in disk 1220, a machine-readable storage medium. The computer program product includes instructions that, when read by a machine, operate to cause a data processing apparatus to receive identification information uniquely identifying an item that has moved through a node in a supply chain, the item being marked with a label claim, to receive, from the node, event data associated with the uniquely identified item, and to output received event data that validates or invalidates the label claim, in real time or near real time to receiving the identification information.

The RAM 1210 interfaces with the computer bus 1227 so as to provide quick RAM storage to the computer CPU 1201 during the execution of software programs such as the operating system application programs, and device drivers. More specifically, the computer CPU 1201 loads computer-executable process steps from the fixed disk drive 1111 or other media into a field of the RAM 1210 in order to execute software programs. Data is stored in the RAM 1210, where the data is accessed by the computer CPU 1201 during execution.

Also shown in FIG. 12, the user device 1101 stores computer-executable code for a operating system 1221, and application programs 1222 such as word processing, spreadsheet, presentation, gaming, web browsing, JavaScript engine, or other applications. Although it is possible to provide for the enhanced label claim validation application using the above-described implementation, it is also possible to implement the functions according to the present disclosure as a dynamic link library (“DLL”), or as a plug-in to other application programs such as an Internet web-browser such as the APPLE® SAFARI® web browser or the MICROSOFT® INTERNET EXPLORER® web browser.

The computer CPU 1201 is one of a number of high-performance computer processors, including an INTEL® or AMD® processor, a POWERPC® processor, a MIPS® reduced instruction set computer (“RISC”) processor, a SPARC processor, an ACORN® RISC Machine (“ARM®”) architecture processor, a HP ALPHASERVER® processor or a proprietary computer processor for a mainframe. In an additional arrangement, the computer CPU 1201 is more than one processing unit, including a multiple CPU configuration found in high-performance workstations and servers, or a multiple scalable processing unit found in mainframes.

The operating system 1221 may be APPLE® MAC OS X® for INTEL® and POWERPC® based workstations and servers; MICROSOFT® WINDOWS NT®/WINDOWS® 2000/WINDOWS® XP Workstation; MICROSOFT® WINDOWS VISTA®/WINDOWS NT®/WINDOWS® 2000/WINDOWS® XP Server; a variety of UNIX®-flavored operating systems, including AIX® for IBM® workstations and servers, SUNOS® for SUN® workstations and servers, LINUX® for INTEL® CPU-based workstations and servers, HP UX WORKLOAD MANAGER® for HP® workstations and servers, IRIX® for SGI® workstations and servers, VAX/VMS for Digital Equipment Corporation computers, OPENVMS® for HP ALPHASERVER®-based computers; SYMBIAN OS®, NEWTON®, IPOD®, WINDOWS MOBILE® or WINDOWS CE®, PALM®, NOKIA® OS (“NOS”), OSE®, or EPOC® for mobile devices, or a proprietary operating system for computers or embedded systems. The application development platform or framework for the operating system 1221 may be: BINARY RUNTIME ENVIRONMENT FOR WIRELESS® (“BREW®”); Java Platform, Micro Edition (“Java ME”) or Java 2 Platform, Micro Edition (“J2ME®”); PYTHON™, FLASH LITE®, or MICROSOFT®.NET Compact.

While FIGS. 11 and 12 illustrate one possible implementation of a computing system that executes program code, or program or process steps, configured to effectuate the enhanced validation of a label claim, other types of computers may also be used as well.

As to formal matters, while the term “user” has been consistently used to describe an entity that interacts with these processes, such a generalization is also intended to describe multiple related or unrelated, living or automated entities or beings that interact with these processes at various different, overlapping or non-overlapping states. In a similar vein, the term “selection” is intended to denote throughout a manual selection by a human, an automatic selection by a non-human, or some combination thereof. Finally, it is noted that, for the sake of brevity, the term “JavaScript” is intended to reference the SUN MICROSYSTEMS® JAVASCRIPT® programming language, and the term “XML” is intended to reference ‘eXtensible Markup Language’ throughout.

A number of implementations have been described. Nevertheless, it will be understood that various modifications may be made without departing from the spirit and scope of the disclosure. Accordingly, other implementations are within the scope of the following claims.

1. A computer-implemented method comprising:
receiving, via a user interface, identification information uniquely identifying an item that has moved through a node in a supply chain, the item being marked with a label claim, the item being transformed from a first, living product to a second, non-living product at the node, and the label claim comprising an organic claim, a natural claim, a no hormone claim, a point-of-origin claim, an ingredients claim, a vegetarian contents claim, a cruelty free claim, a drug claim, a cosmetic claim, a cage-free claim, or a compliance claim;
establishing a data collection interface between the node and a transaction database, the data collection interface allowing the transaction database to receive event data associated with the uniquely identified item from the node;
receiving, from the node, the event data associated with the uniquely identified item, the event data further comprising an event identification number attribute, a type attribute, a nomenclature attribute, a quantity attribute, a unit-of measurement attribute, a parent event identification number attribute, or a child event identification number attribute, and the event data being associated with a vaccination event, a harvesting event, a birthing event, or a transportation event, a treatment event, a planting event, a location event, a containering event, or a cohorting event;
establishing a data conversion interface between the user interface and the transaction database, the data conversion interface allowing the output of the received event data from the transaction database using the user interface;
automatically validating the label claim of the item based on the received event data; and
outputting, via the user interface, received event data that validates the label claim, in real time or near real time to receiving the identification information, if the label claim is automatically validated, the received event data that validates the label claim further comprising event data associated with the first product and event data associated with the second product.

2. A computer-implemented method comprising:
receiving identification information uniquely identifying an item that has moved through a node in a supply chain, the item being marked with a label claim;
receiving, from the node, event data associated with the uniquely identified item; and
outputting received event data that validates or invalidates the label claim, in real time or near real time to receiving the identification information.

3. The method of claim 2, wherein receiving the identification information further comprises:
generating a user interface; and
receiving the identification information from a user via the generated user interface.

4. The method of claim 2, wherein the identification information is received using a radio frequency identification device (RFID) reader.

5. The method of claim 2, further comprising establishing a data collection interface between the node and a transaction database, the data collection interface allowing the transaction database to receive the event data associated with the uniquely identified item from the node.

6. The method of claim 2, wherein the event data relates supply chain processing of the uniquely identified item at the node.

7. The method of claim 2, wherein the identification information is received before the event data is received from the node.

8. The method of claim 2, further comprising establishing a data conversion interface between an output device and a transaction database, the data conversion interface allowing the output of the received event data from the transaction database using the output device.

9. The method of claim 2, further comprising automatically validating the label claim of the item based on the received event data.

10. The method of claim 2, further comprising:
receiving, from a second node, event data associated with the uniquely identified item; and
reformatting the event data received from the node and the second node,
wherein outputting the received event data further comprises outputting the reformatted event data received from the node and the second node.

11. The method of claim 2, further comprising:
receiving identification information uniquely identifying a component of the uniquely identified item based on outputting the received event data;
receiving, from a second node on the supply chain, component event data associated with the component; and
outputting received component event data that validates or invalidates the label claim, in real time or near real time to receiving the identification information uniquely identifying the component.

12. The method of claim 2,
wherein the item is transformed from a first product to a second product at the node, and
wherein the output received event data that validates the label claim further comprises event data associated with the first product and event data associated with the second product.

13. The method of claim 12, wherein the first product is a living product, and wherein the second product is a non-living product.

14. The method of claim 13,
wherein the first product is a living animal, fruit or vegetable, and
wherein the second product is a meat product or a harvested fruit or vegetable.

15. The method of claim 2, wherein the event data further comprises an event identification number attribute, a type attribute, a nomenclature attribute, a quantity attribute, a unit-of measurement attribute, a parent event identification number attribute, or a child event identification number attribute.

16. The method of claim 2, wherein the label claim is an organic claim, a natural claim, a no hormone claim, a point-of-origin claim, an ingredients claim, a vegetarian contents claim, a cruelty free claim, a drug claim, a cosmetic claim, a cage-free claim, or a compliance claim.

17. The method of claim 2, wherein the identification information is physically affixed to the item or packaging of the item.

18. The method of claim 2, wherein the label claim is physically affixed to the item or packaging of the item.

19. The method of claim 2, wherein the event data is associated with a vaccination event, a harvesting event, a birthing event, or a transportation event, a treatment event, a planting event, a location event, a containering event, or a cohorting event.

20. A device comprising:
an interface configured to:
receive identification information uniquely identifying an item that has moved through a node in a supply chain, the item being marked with a label claim,
receive, from the node, event data associated with the uniquely identified item, and
output received event data that validates or invalidates the label claim, in real time or near real time to receiving the identification information.

21. A computer program product, tangibly embodied in a machine-readable medium, the computer program product comprising instructions that, when read by a machine, operate to cause a data processing apparatus to:
receive identification information uniquely identifying an item that has moved through a node in a supply chain, the item being marked with a label claim;
receive, from the node, event data associated with the uniquely identified item; and output received event data that validates or invalidates the label claim, in real time or near real time to receiving the identification information.
